(19) United States
(12) Patent Application Publication
(10) Pub. No.: US 2009/0116874 A1
(43) Pub. Date: May 7, 2009

(54) ELECTROPHOTOGRAPHIC PHOTORECEPTOR AND METHOD FOR IMAGE FORMATION USING SAID ELECTROPHOTOGRAPHIC PHOTORECEPTOR

(75) Inventor: Shunichiro Kurihara, Kanagawa (JP)

Correspondence Address: OBLON, SPIVAK, MCCLELLAND MAIER & NEUSTADT, P.C., 1940 DUKE STREET, ALEXANDRIA, VA, 22314, US

(73) Assignee: Mitsubishi Chemical Corporation, Minato-ku (JP)

(21) Appl. No.: 11/915,470

(22) PCT Filed: May 24, 2006
(86) PCT No.: PCT/JP2006/310374

§ 371 Date: May 9, 2008

(30) Foreign Application Priority Data
May 24, 2005 (JP) 2005-150503
May 25, 2005 (JP) 2005-151841

(51) Int. Cl. G03G 15/02; G03G 5/06

(52) U.S. Cl. 399/176; 430/56

(57) ABSTRACT

An image-forming method employing an electrophotographic process is provided with which images having high resolution can be obtained and which is less apt to cause image defects even in repetitions of use, does not cause conspicuous image defects even under severe conditions suitable for high resolution, and has excellent electrical characteristics. The object has been accomplished with an electrophotographic photoreceptor for developing an electrostatic latent image formed in the surface thereof with a polymerization toner, the electrophotographic photoreceptor comprising a photosensitive layer which contains a polymer comprising a repeating unit including a partial structure represented by formula (1).

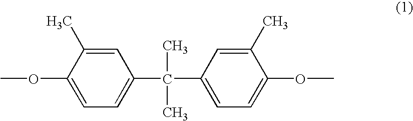

### TECHNICAL FIELD

The present invention relates to an electrophotographic photoreceptor for use in copiers, printers, and the like which employ an electrophotographic process. More particularly, the invention relates to an electrophotographic photoreceptor which, even when used for development with a polymerization toner, has excellent durability and does not cause image defects such as fogging and memory.

### BACKGROUND ART

Electrophotography is extensively used and applied in recent years not only in the field of copiers but in the field of various printers because of its instantaneousness, ability to give high-quality images, etc. With respect to electrophotographic photoreceptors in electrophotography, photoreceptors employing an organic photoconductive material having advantages such as non-polluting properties, ease of film formation, and ease of production have been developed recently.

Known electrophotographic photoreceptors employing an organic photoconductive material include the so-called dispersion type photoreceptor comprising a binder resin and fine photoconductive particles dispersed therein and the multilayered photoreceptor having superposed layers comprising a charge-generating layer and a charge-transporting layer. Known as such multilayered photoreceptors are: a normal superposition type multilayered photoreceptor in which a charge-generating layer and a charge-transporting layer have been superposed in this order on a conductive base; and a reversed superposition type multilayered photoreceptor in which a charge-transporting layer and a charge-generating layer have been superposed in this order.

Of those photoreceptors, the multilayered photoreceptors have energetically been developed and come to be mainly used practically as electrophotographic photoreceptors. This is because an electrophotographic photoreceptor having high sensitivity is obtained by using a charge-generating substance and a charge-transporting substance both having high efficiency in combination, because there is a wide choice of materials and a highly safe electrophotographic photoreceptor is obtained, and because the coating operations contribute to high productivity and are relatively advantageous in cost.

On the other hand, with respect to toners for use in electrophotographic processes, polymerization toners have been developed as a substitute for conventional pulverization toners because of their advantages, for example, that one having a relatively small particle diameter is obtained and a narrow particle diameter distribution is attained.

Incidentally, since the electrophotographic photoreceptor is repeatedly used in an electrophotographic process, i.e., cycles each comprising charging, exposure, development, transfer, cleaning, erase, etc., it receives various stresses and deteriorates.

Examples of such deteriorations include the chemical damage to the photosensitive layer caused by the ozone, which is highly oxidative, and NOₓ generated by the corona charging device commonly used as a charging device and chemical and electrical deteriorations caused, for example, by the flow of carriers (current) generated by image-wise exposure through the photosensitive layer or by the decomposition of the photosensitive layer composition due to erase light or external light.

Examples thereof further include mechanical deterioration which occurs when the electrophotographic photoreceptor comes into contact with the toner, paper, and cleaning member in the development, transfer, and cleaning steps. Especially when a polymerization toner having a relatively small particle diameter and a nearly spherical particle shape is used, it is necessary to bring the cleaning member, e.g., a cleaning blade, into hard contact with the electrophotographic photoreceptor and, hence, there has been a problem concerning, in particular, the mechanical deterioration of the electrophotographic photoreceptor.

Such deteriorations have resulted in image defects, such as fogging, memory, white streaks, black streaks, white blind areas, black blind areas, white spots, and black spots, and have been factors which shorten the life of the electrophotographic photoreceptor.

Furthermore, especially in the case where a polymerization toner is used, sharp images having satisfactory resolution are obtained because this toner generally has a small average particle diameter and, hence, the image defects are apt to be conspicuous. Consequently, there has been a desire for an electrophotographic photoreceptor which is more inhibited from deteriorating with repetitions of use.

The part which is apt to receive electrical, chemical, or mechanical loading generally is the outermost layer. Except the cases where a protective layer or the like is present, the outermost layer is the photosensitive layer itself in dispersion type photoreceptors and is the charge-transporting layer in the case of normal superposition type multilayered photoreceptors. From the standpoint of mechanical deterioration only, the strength of, in particular, the outermost layer is the most important factor.

On the other hand, various thermoplastic resins and thermosetting resins are used as binder resins for outermost layers. Among such numerous binder resins are various polycarbonate resins which have been developed and put to practical use (see, for example, patent document 1).

However, there has been the following problem. The photosensitive layer of a dispersion type photoreceptor and the charge-transporting layer of a normal superposition type multilayered photoreceptor, which each are the outermost layer, generally comprise a binder resin and a photoconductive substance. Because the content of this photoconductive substance is considerably high, it has been impossible to impart sufficient mechanical strength. In particular, it has been impossible to enhance the mechanical strength of the outermost layer to such a degree that the photoreceptor can sufficiently withstand the load imposed by, e.g., the cleaning member in development with a polymerization toner.

Consequently, there has been a desire for an organic electrophotographic photoreceptor which can be sufficiently inhibited from deteriorating even in development with a polymerization toner necessitating the use of an increased cleaning blade contact pressure and which has higher durability and does not cause the image defects even when a polymerization toner attaining satisfactory resolution and apt to give conspicuous image defects is used.

### Patent Document 1: JP-A-63-148263

### DISCLOSURE OF THE INVENTION

### Problem that the Invention is to Solve

The invention has been achieved in view of such background techniques. An object of the invention is to provide an electrophotographic photoreceptor with which images having high resolution can be obtained and which is less apt to cause image defects even in repetitions of use, does not cause conspicuous image defects even under severe conditions suitable for high resolution, and has excellent electrical characteristics.

### Means for Solving the Problem

The present inventor made intensive investigations in order to overcome the problem described above. As a result, it has been found that an electrophotographic photoreceptor which overcomes the problem described above without impairing electrical characteristics such as electrification characteristics, sensitivity, and residual potential, applicability, and other performances can be obtained by incorporating a specific polymer as a binder resin for the outermost layer of the electrophotographic photoreceptor. It has been further found that when this electrophotographic photoreceptor is used in combination with a polymerization toner, images having high resolution can be obtained and the photoreceptor is less apt to cause image defects even in severe repetitions of use with the polymerization toner and causes no conspicuous image defects and has excellent durability even under conditions suitable for high resolution. The invention has been achieved based on these findings.

Namely, the invention provides an electrophotographic photoreceptor for developing an electrostatic latent image formed in the surface thereof with a polymerization toner, the electrophotographic photoreceptor comprising a photosensitive layer which contains a polymer comprising a repeating unit including a partial structure represented by formula (1).

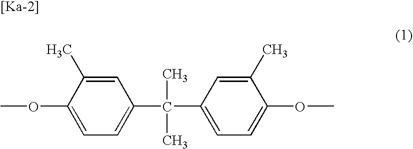

The invention further provides an image-forming apparatus comprising the electrophotographic photoreceptor.

### ADVANTAGES OF THE INVENTION

According to the invention, an electrophotographic photoreceptor having excellent electrical characteristics can be provided with which images having high resolution can be obtained and which does not cause image defects such as image fogging and memory even in repetitions of use, not to mention just after the initiation of use. The photoreceptor has excellent durability and, even through repetitions of use, the high-resolution images change little. The coating fluid for photosensitive-layer formation has satisfactory applicability. Furthermore, an electrophotographic photoreceptor can be provided in which the photosensitive layer is less apt to suffer physical deterioration, e.g., film loss, during repetitions of use even when charged with a contact charging member and which has excellent electrical characteristics.

### BRIEF DESCRIPTION OF THE DRAWINGS

FIG. 1 is a diagrammatic view illustrating an example of image-forming apparatus employing the electrophotographic photoreceptor of the invention.

FIG. 2 is a diagrammatic view illustrating an example of roller type constant charging devices.

### DESCRIPTION OF THE REFERENCE NUMERALS AND SIGNS

1 photoreceptor
2 charging device
2a charging roller
21 core of charging roller
22 roller type contact charging member (supporting member of charging roller)
23 roller type contact charging member (surface member of charging roller)
3 exposure device
4 developing device
5 transfer device
6 cleaner
7 fixing device
41 developing chamber
42 agitator
43 feed roller
44 developing roller
45 control member
71 upper fixing member (fixing roller)
72 lower fixing member (fixing roller)
73 heater
T toner
P recording paper

### BEST MODE FOR CARRYING OUT THE INVENTION

It is essential in the invention that the photosensitive layer of the electrophotographic photoreceptor should contain at least one polymer comprising repeating units including the partial structure represented by formula (1).

Although the photosensitive layer in an electrophotographic photoreceptor in the invention is not particularly limited, the effects of the invention are apt to be produced when the photosensitive layer is the outermost layer of an electrophotographic photoreceptor. Namely, it is preferred that the photosensitive layer in the invention should be the photosensitive layer itself in a dispersion type photoreceptor and be the charge-transporting layer in a normal superposition type multilayered photoreceptor, except the cases where the photoreceptor has a protective layer or the like.

The polymer comprising repeating units including the partial structure represented by formula (1) (hereinafter abbreviated to “polymer of the invention”) means a polymer in which the smallest repeating units include the partial structure represented by formula (1) and which is constituted substantially of these repeating units.

The repeating units including the partial structure represented by general formula (1) are not particularly limited as to what organic group is bonded to each or one end of the partial structure. As long as a polymer comprises repeating units including this partial structure, it can be the polymer of the invention and the effects of the invention are obtained. However, it is especially preferred that the partial structure in each repeating unit should be one formed by the polycondensation of a bisphenol ingredient.

The basic framework of the main chain of the polymer of the invention is not particularly limited. However, it preferably is a polycarbonate and/or a polyester.

Examples of the repeating units including the partial structure represented by formula (1) include repeating units represented by formula (2) and repeating units represented by formula (3).

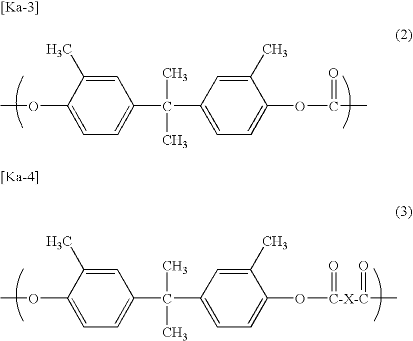

In formula (3), X represents any desired divalent organic group. Examples of X include alkylene groups such as methylene and ethylene; arylene groups such as phenylene and naphthylene; aromatic-ring-containing sulfides such as diphenyl sulfide; and aromatic-ring-containing ethers such as diphenyl ether. Preferred examples of X include arylenes and aromatic-ring-containing ethers. Especially preferred examples thereof include phenylene and diphenyl ether. More preferred is the phenylene group which is a residue of terephthalic acid.

The polymer of the invention is a polymer which comprises a repeating unit including the partial structure represented by formula (1) as the smallest repeating units and which is constituted of the repeating unit. Namely, copolycondensation for incorporating other repeating units is not excluded as long as the effects of the invention are not lessened thereby. In the invention, a polymer consisting substantially of such repeating units is used.

As long as the polymer contained in the photosensitive layer consists substantially of repeating units including the partial structure represented by formula (1), an electrophotographic photoreceptor having sufficient durability even when used in combination with a polymerization toner is obtained. Preferred is a polymer consisting only of repeating units including the partial structure repeated by formula (1).

When the polymer contains, incorporated through copolycondensation, a large amount of repeating units other than the repeating units including the partial structure represented by formula (1), then there are cases where the photosensitive layer does not have mechanical strength or where repetitions of use result in an increased value of fogging or memory. In addition, when a cleaning member is forcedly applied to this photosensitive layer, e.g., the linear pressure of a cleaning blade is increased, for the removal of a polymerization toner, there are cases where sufficient durability is not obtained. On the other hand, in the case where the polymer is one consisting substantially of the repeating unit of formula (1), excellent mechanical strength is obtained.

The photosensitive layer of the electrophotographic photoreceptor of the invention preferably contains a polycarbonate consisting substantially of repeating units represented by formula (2) and/or a polyester consisting substantially of repeating units represented by formula (3).

Of these, the polymer comprising repeating units represented by formula (2) is especially preferably used because it is excellent especially in durability in repetitions of use.

The polymer of the invention has a viscosity-average molecular weight of generally 10,000 or higher, preferably 20,000 or higher, especially preferably 30,000 or higher, because too low molecular weights result in insufficient mechanical strength. On the other hand, when the viscosity-average molecular weight of the polymer is too high, there are cases where the coating fluid for photosensitive-layer formation has too high a viscosity, resulting in reduced productivity. Consequently, the viscosity-average molecular weight thereof is generally 150,000 or lower, preferably 100,000 or lower, especially preferably 50,000 or lower.

In the invention, the viscosity-average molecular weight is defined as one determined through a measurement and calculation by the following method.

A polymer is dissolved in dichloromethane to prepare a solution having a concentration C of 6.00 g/L. An Ubbelode's capillary viscometer having a solvent (dichloromethane) efflux time to (sec) of 136.16 seconds is used to measure the efflux time t (sec) of the sample solution in a thermostatic water tank set at 20.0° C. The viscosity-average molecular weight Mv is calculated according to the following equations.

$$\begin{matrix}a = 0.438 {η}_{sp} + 1 & wherein {η}_{sp} = ( t \text{/} {t}_{0} ) - 1 \\ b = 100 {η}_{sp} / C & wherein C = 6.00 ( g \text{/} L ) \\ η = b / a & \\ Mv = 3207 {η}^{1.205} & \end{matrix}$$

Methods for synthesizing a polycarbonate comprising, for example, repeating units represented by formula (2) are not particularly limited, and the polycarbonate can be synthesized by ordinary methods. For example, it can be synthesized by the production process described in JP-A-63-148263.

Methods for synthesizing a polyester comprising, for example, repeating units represented by formula (3) are not particularly limited, and the polyester can be synthesized by ordinary methods. For example, it can be synthesized by the production process described in JP-A-9-22126.

The photosensitive layer of the electrophotographic photoreceptor of the invention may contain a binder resin other than the polymer of the invention. Examples of the resin which may be optionally used include thermoplastic resins and thermoset resins, such as polymers or copolymers of vinyl compounds such as methyl methacrylate, styrene, and vinyl chloride; polycarbonates other than the polymer of the invention; polyesters other than the polymer of the invention; and polysulfones, phenoxy resins, epoxy resins, and silicone resins. Preferred of these resins are polycarbonate resins other than the polymer of the invention and polyester resins other than the polymer of the invention.

Examples of the polycarbonate resins and polyester resins other than the polymer of the invention include ones comprising repeating units represented by any of formula (4) to formula (7).

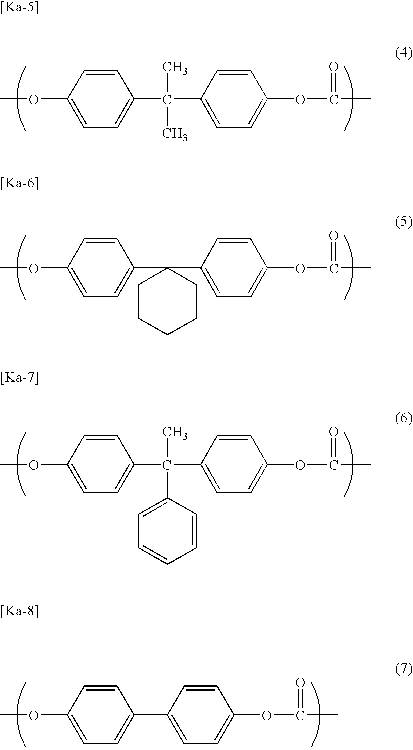

In the case where the photosensitive layer contains one or more binder resins other than the polymer of the invention, the proportion of the polymer of the invention contained in the layer is preferably 50% by mass or higher, especially preferably 80% by mass or higher, based on all binder resins in the photosensitive layer from the standpoint of maintaining the mechanical properties of the electrophotographic photoreceptor of the invention. More preferred is the case where one or more polymers comprising repeating units including the partial structure represented by formula (1) (polymers of the invention) are contained substantially as the only binder resin in the photosensitive layer.

It is preferred that the electrophotographic photoreceptor of the invention be charged with a contact charging member in contact with the electrophotographic photoreceptor from the standpoint of taking advantage of the excellent durability which is a feature of the photoreceptor. It is especially preferred that the contact charging member be a roller type contact charging member.

For example, in the case where the contact charging device is a roller type contact charging member, the charging roller 2 is usually constituted at least of a core and a contact charging member with which the periphery of the core is covered. The contact charging member preferably is a conductive or semiconductive elastomer having a relatively low surface hardness and a low modulus because the charging member is required to be in intimate contact with the photoreceptor. For example, it is preferred to use a conductive rubber obtained by incorporating conductive particles, e.g., carbon, or semiconductor particles made of another material into a rubber material. Furthermore, a function allocation type charging member also is especially preferred which is a contact charging member comprising a supporting member and a surface member and in which the supporting member is made to have a moderate hardness so as to maintain intimate contact with the photoreceptor and the surface member is made to retain moderate electrical resistance. The embodiment employing a roller type charging member is explained in more detail by reference to FIG. 2.

In FIG. 2, numeral 1 denotes an electrophotographic photoreceptor. The shape of the photoreceptor may be any of drum, sheet, belt, and other forms. Numerals 21 denotes a core which supports the contact charging member. Both ends of this core 21 are held by bearings supported by an appropriate pressure-applying device, e.g., a metallic spring, so as to keep the contact charging member in contact with the electrophotographic photoreceptor 1. A bias potential is applied to the bearings for the core 21 either directly or by means of another electrical contact device. The material of the core 21 is not particularly limited as long as it has conductivity. However, a metal is generally used. Examples of the metal include iron, copper, brass, stainless steel, and aluminum. Besides these, a conductive organic material may be used, such as, e.g., a resin molding into which carbon has been incorporated.

In FIG. 2, numeral 22 denotes a roller type supporting member. The supporting member rotates while being in intimate contact with the electrophotographic photoreceptor. A driving force for rotation may be externally applied, or the supporting member 22 may be allowed to freely rotate by the force of contact friction with the electrophotographic photoreceptor 1. The material of the supporting member 22 is not particularly limited as long as it is conductive or semiconductive. However, from the standpoint of the necessity of keeping the charging member in intimate contact with the electrophotographic photoreceptor 1, use is made of a rubber material having a relatively low surface hardness, such as, e.g., NBR, EPDM, silicone, Neoprene, or natural rubber material, or a conductive rubber material comprising any of these rubber materials and conductive particles, e.g., carbon, or semiconductive particles incorporated therein. It is a matter of course that a material which is not a low-modulus material such as rubbers may be used as the material of the supporting member 22 as long as it has a highly precisely processed surface so as to maintain satisfactory intimate contact.

In the case where the roller type contact charging device 2a described above is used, there may be a problem concerning evenness of charging. In case where the volume resistivity of the contact charging member is too high, the electrophotographic photoreceptor is unevenly charged and this is apt to result in image unevenness in black areas in normal development or in fogging in white areas in reversal development. Conversely, when the volume resistivity thereof is too low, there are cases where charging failures occur and the electrophotographic photoreceptor 1 is not sufficiently charged. Consequently, the volume resistivity of the supporting member 22 is preferably 10²-10¹⁵ Ωcm, especially preferably 10⁴-10¹² Ωcm, in terms of volume resistivity as measured by the method in accordance with IEC 60093.

Numeral 23 in FIG. 2 denotes a surface member, which is disposed in the case of using a function allocation type charging member. The material of the surface member 23 is not particularly limited. However, a resin selected from polyamide resins, fluororesins, vinyl chloride resins, acrylic resins, other various polyester resins, and the like may be used as the main component. The volume resistivity of the surface member 23 is preferably 10³-10¹⁴ Ωcm, especially preferably 10⁵-10¹² Ωcm, in terms of volume resistivity as measured by the method in accordance with IEC 60093. It is preferred that the surface member 23 should have a larger film thickness when the durability of the charging member under wearing is taken into account. However, too large thicknesses impair the ability to charge the electrophotographic photoreceptor 1. Consequently, the thickness thereof is in the range of generally 0.01-1,000 μm, preferably 0.1-500 μm. It is preferred that the surface member 23 be formed on the supporting member 22 by dipping, spraying, vacuum deposition, plasma coating, or the like.

The voltage to be applied to the charging member, i.e., the core 21, in order to charge the electrophotographic photoreceptor 1 may be a direct-current voltage alone or may be one obtained by superimposing an alternating current on a direct current. The alternating current is not particularly limited in voltage waveform as long as the voltage changes periodically. The range of voltages in the case of a direct-current voltage is preferably 100-4,000 V, especially preferably 300-3,000 V, on the positive or negative side. With respect to the alternating-current voltage to be superimposed, the peak-to-peak voltage is preferably 100-4,000 V, especially preferably 300-3,000 V. The charging member preferably is one which charges the photoreceptor with a direct-current voltage because the mechanical vibrations thereof are small.

Embodiments of the electrophotographic photoreceptor of the invention, processes for producing the photoreceptor, etc. will be explained below with respect to each constituent part.

### <Conductive Substrate>

The electrophotographic photoreceptor of the invention is generally constituted of a conductive substrate and a photosensitive layer formed thereover. As the conductive substrate can be used any of the conductive substrates employed in known electrophotographic photoreceptors. Examples thereof include drums or sheets made of a metallic material such as aluminum, an aluminum alloy, stainless steel, copper, nickel, zinc, indium, gold, or silver, materials to which a foil of any of these metals has been laminated, materials coated with any of those metals by vapor deposition, and insulating substrates, such as polyester films, paper, and glasses, which have a conductive layer of, e.g., aluminum, copper, palladium, tin oxide, indium oxide, ITO (indium-tin oxide), or a conductive polymer formed on a surface thereof. Examples thereof further include plastic films, plastic drums, paper, paper tubes, and the like which have undergone a conductivity-imparting treatment comprising applying a conductive substance such as a metal powder, carbon black, copper iodide, or polymeric electrolyte together with an appropriate binder. Examples thereof furthermore include plastic sheets or drums to which conductivity has been imparted by incorporating a conductive substance such as a metal powder, carbon black, or carbon fibers. Examples thereof still further include plastic films or belts which have undergone a conductivity-imparting treatment with a conductive metal oxide such as tin oxide or indium oxide.

The surface of the conductive substrate may be subjected to any of various treatments, e.g., a surface oxidation treatment or chemical treatment, as long as this does not influence image quality. In the case where a metallic material such as, e.g., an aluminum alloy is employed as the conductive substrate, it may be used after having been subjected to an anodization treatment, chemical conversion coating treatment, etc. It is desirable that when an anodization treatment is performed, the substrate be then subjected to a pore-filling treatment by a known method.

The surface of the conductive substrate may be smooth or may have been roughened by a special machining method or by conducting an abrading treatment. Alternatively, the conductive substrate may be one which has been made to have a rough surface by incorporating particles having an appropriate particle diameter into the material constituting the substrate.

The conductive substrate can have any desired shape such as, e.g., a drum, sheet, belt, seamless belt, or the like.

### <Undercoat Layer>

An undercoat layer may be disposed between the conductive substrate and the photosensitive layer for the purpose of improving adhesiveness, blocking properties, etc. As the undercoat layer may be used a layer comprising a resin or comprising a resin and particles of, e.g., a metal oxide dispersed therein. Examples of the metal oxide particles for use in the undercoat layer include particles of a metal oxide containing one metallic element, such as titanium oxide, aluminum oxide, silicon oxide, zirconium oxide, zinc oxide, or iron oxide, and particles of a metal oxide containing two or more metallic elements, such as calcium titanate, strontium titanate, or barium titanate. Metal oxide particles of one kind only may be used, or a mixture of particles of two or more kinds may be used.

Preferred of those particulate metal oxides are titanium oxide and aluminum oxide. Titanium oxide is especially preferred. The titanium oxide particles may be ones whose surface has undergone a treatment with an inorganic substance such as tin oxide, aluminum oxide, antimony oxide, zirconium oxide, or silicon oxide or with an organic substance such as stearic acid, a polyol, or a silicone. The crystal form of the titanium oxide particles may be any of rutile, anatase, brookite, amorphous, etc. The titanium oxide may comprise ones having two or more crystal states. Before being used, such metal oxide particles may be subjected to a surface treatment for the purpose of improving dispersibility in a coating fluid and environmental properties. Surface-treating agents for the metal oxide particles are not particularly limited as long as the particles treated do not adversely influence the properties of the electrophotographic photoreceptor. It is, however, preferred to use a reactive organosilicon compound.

With respect to the particle diameter of the metal oxide particles, metal oxides having various particle diameters can be utilized. From the standpoints of properties and liquid stability, however, the average primary-particle diameter thereof is preferably 10-100 nm, especially preferably 10-50 nm.

An electron-transporting organic pigment may be incorporated either alone or in combination with any of the inorganic metal oxides. This pigment is not particularly limited as long as it is an organic pigment having the ability to transport electrons. Examples thereof include polycyclic quinone pigments, perylene pigments, azo pigments, indigo pigments, and quinacridone pigments.

It is desirable that the undercoat layer be formed in the form of a dispersion of metal oxide particles in a binder resin. Examples of the binder resin to be used in the undercoat layer include phenoxy resins, epoxy resins, polyvinylpyrrolidone, poly(vinyl alcohol), casein, poly((meth) acrylic acid), cellulose and derivatives thereof, gelatin, starch, polyurethanes, polyimides, and polyamides. These resins may be cured alone or in combination with a hardener. Of these, alcohol-soluble copolyamides, modified polyamides, and the like are preferred because they are satisfactory in dispersibility and applicability. The proportion of the inorganic particles to the binder resin can be selected at will. However, from the standpoint of the stability and applicability of the dispersion, it is preferred to use the particles in an amount in the range of 10-500% by mass.

The thickness of the undercoat layer can be selected at will. However, it is preferably in the range of 0.1-20 μm from the standpoints of photoreceptor properties and applicability. The undercoat layer may contain a known antioxidant or the like.

### <Constitution of Photosensitive Layer>

The photosensitive layer of the electrophotographic photoreceptor of the invention may be either a photosensitive layer of the so-called multilayer type or a photosensitive layer of the dispersion type. However, a normal superposition type multilayered photosensitive layer is preferred when the mechanical properties, electrical characteristics, and production stability of the electrophotographic photoreceptor, etc. are comprehensively taken into account.

### <<Multilayer Type Photosensitive Layer>>

Charge-Generating Layer

In the case where the electrophotographic photoreceptor of the invention is a multilayer type photoreceptor, preferred examples of the charge-generating substance for use in the charge-generating layer of this photoreceptor include selenium and alloys thereof; inorganic photoconductive materials such as cadmium sulfide; and organic pigments such as phthalocyanine pigments, azo pigments, quinacridone pigments, indigo pigments, perylene pigments, polycyclic quinone pigments, anthanthrone pigments, and benzimidazole pigments. Especially preferred are organic pigments such as phthalocyanine pigments and azo pigments.

In the case where a phthalocyanine compound is used as a charge-generating substance, examples thereof include metal-free phthalocyanines and phthalocyanine compounds to which a metal, e.g., copper, indium, gallium, tin, titanium, zinc, vanadium, silicon, or germanium, or an oxide, halide, or another form of the metal has coordinated. Examples of ligands coordinated to metal atoms having a valence of 3 or higher include hydroxyl and alkoxy groups besides the ligands shown above, i.e., oxygen and chlorine atoms. Preferred of those are X-form and T-form metal-free phthalocyanines, which have especially high sensitivity, A-form, B-form, D-form, and other titanyl phthalocyanines, vanadyl phthalocyanines, chloroindium phthalocyanines, chlorogallium phthalocyanines, and hydroxygallium phthalocyanines. Of the crystal forms of titanyl phthalocyanines shown above, the A-form and the B-form are shown as the I-phase and II-phase, respectively, by W. Heller et al. (Zeit. Kristallogr., 159 (1982) 173), the A-form being known as a stable form. The D-form is a crystal form characterized by showing a distinct peak at a diffraction angle 2θ±0.2° of 27.3° in X-ray powder diffractometry using CuK_{α} characteristic X-ray.

A single phthalocyanine compound only may be used, or some phthalocyanine compounds in the form of a mixture thereof may be used. For forming the mixed state of phthalocyanine compounds or forming a mixed crystal state, use may be made of a method in which the constituent elements may be mixed later and used. Alternatively, the compounds may be ones which were made to come into the mixed state in the phthalocyanine compound production/treatment steps including synthesis, pigment preparation, and crystallization. As such treatments may be used an acid paste treatment, grinding treatment, solvent treatment, and the like.

The charge-generating substance is used either alone or together with a binder resin to form a charge-generating layer. Examples of the binder resin include poly(vinyl acetate), poly(acrylic ester)s, poly(methacrylic ester)s, polyesters, polycarbonates, poly(vinyl acetoacetal), poly(vinyl propional), poly(vinyl butyral), phenoxy resins, epoxy resins, urethane resins, cellulose esters, and cellulose ethers; polymers or copolymers of vinyl compounds such as styrene, vinyl acetate, vinyl chloride, acrylic esters, methacrylic esters, vinyl alcohol, and ethyl vinyl ether; and polyamides and silicone resins.

The proportion of the charge-generating substance to be used is generally 5-500 parts by weight, preferably 20-300 parts by weight, per 100 parts by weight of the binder resin. The thickness of the charge-generating layer is generally 0.01-5 μm, preferably 0.05-2 μm, more preferably 0.15-0.8 μm.

The charge-generating layer may contain various additives according to need, such as, e.g., a leveling agent for applicability improvement, an antioxidant, and a sensitizer.

For forming a charge-generating layer, use may be made of a method which comprises dispersing or dissolving the charge-generating substance in an appropriate dispersion medium with a ball mill, ultrasonic disperser, paint shaker, attritor, sand grinder, or the like, optionally adding a binder resin thereto to prepare a coating fluid for forming a charge-generating layer, and applying this coating fluid to form the layer. In the case where the charge-generating substance is used alone, the charge-generating layer may be formed by applying a coating fluid prepared without adding a binder to the dispersion or by a method such as vapor deposition or sputtering.

Charge-Transporting Layer

In the case where the electrophotographic photoreceptor of the invention has a function allocation type photosensitive layer, the charge-transporting layer is constituted at least of a charge-transporting substance and a polymer comprising repeating units including the partial structure represented by formula (1) (polymer of the invention).

Examples of the charge-transporting substance to be used in the charge-transporting layer include diphenoquinone derivatives, aromatic nitro compounds such as 2,4,7-trinitrofluorenone, heterocyclic compounds such as carbazole derivatives, indole derivatives, imidazole derivatives, oxazole derivatives, pyrazole derivatives, oxadiazole derivatives, pyrazoline derivatives, and thiadiazole derivatives, aniline derivatives, hydrazone compounds, aromatic amine derivatives, stilbene derivatives, butadiene derivatives, enamine compounds, compounds made up of two or more of these compounds bonded to each other, and polymers having a group derived from any of these compounds in the main chain or a side chain. A mixture of two or more of these charge-transporting substances may be used.

The proportion of the charge-transporting substance to the binder resin in the invention is preferably 10 parts by weight or larger, especially preferably 30 parts by weight or larger, per 100 parts by weight of the binder resin. The proportion thereof is preferably 200 parts by weight of smaller, especially preferably 150 parts by weight or smaller. Too large proportions of the binder resin may result in impaired electrical characteristics. The charge-transporting substance usually is compatible with the binder resin and highly influences the mechanical properties of the photosensitive layer. Because of this, when the proportion of the charge-transporting substance is too large, there are cases where the photosensitive layer has reduced mechanical strength and the effects of the invention are not obtained.

Known additives such as plasticizers, lubricants, dispersing aids, antioxidants, ultraviolet absorbers, electron-attracting compounds, dyes, pigments, sensitizers, and leveling agents may be incorporated into the charge-transporting layer in the invention for the purpose of improving film-forming properties, flexibility, mechanical strength of the layer, applicability, nonfouling properties, gas resistance, light resistance, etc. Besides these, various additives can be used in order to further improve the mechanical strength and durability of the coating film. Examples of such additives include known plasticizers, stabilizers, flowability imparters, and crosslinking agents. Examples of the antioxidants include hindered phenol compounds and hindered amine compounds. Examples of the dyes and pigments include various colorant compounds and azo compounds. Examples of the surfactants include silicone oils and fluorochemical oils.

The thickness of the charge-transporting layer is generally 10-50 μm, preferably 13-35 μm.

### <<Dispersion Type Photosensitive Layer>>

In the case where the electrophotographic photoreceptor of the invention has a dispersion type photosensitive layer, a charge-generating substance is used, together with a charge-transporting substance, in the state of being dispersed or dissolved in a layer comprising a polymer comprising repeating units including the partial structure represented by formula (1) (polymer of the invention).

In this constitution, the charge-generating substance should have a sufficiently small particle diameter. It is used in the state of having a particle diameter of preferably 1 μm or smaller, more preferably 0.5 μm or smaller. The amount of the charge-generating substance to be dispersed or dissolved in the dispersion type photosensitive layer is in the range of, for example, 0.5-50% by mass based on the whole photosensitive layer. Too small amounts thereof make it impossible to obtain sufficient sensitivity, while too large amounts thereof produce adverse influences and result in a decrease in electrification characteristics, decrease in sensitivity, etc. Especially preferably, the charge-generating substance is used in an amount in the range of 1-20% by mass. The proportion of the charge-transporting substance to the binder resin is preferably 30 parts by weight or larger, especially preferably 40 parts by weight or larger, per 100 parts by weight of the binder resin. The proportion thereof is preferably 80 parts by weight or smaller, especially preferably 60 parts by weight or smaller.

As in the charge-transporting layer in the multilayer type photosensitive layer, too large proportions of the binder resin may result in impaired electrical characteristics. Furthermore, since the charge-transporting substance usually is compatible with the binder resin, too large proportions of the charge-transporting substance may result in cases where the photosensitive layer has reduced mechanical strength and the effects of the invention are not obtained. The same additives as those which can be incorporated into the charge-transporting layer in the multilayer type photosensitive layer can be used in the dispersion type photosensitive layer.

A coating fluid obtained is applied to a conductive substrate and dried to form the photosensitive layer. This layer has a thickness of generally 2-70 μm, preferably 10-45 μm, especially preferably 20-35 μm.

### <Coating Fluid for Forming Photosensitive Layer>

Examples of solvents and dispersion media usable in forming the layers through coating fluid application include butylamine, diethylamine, ethylenediamine, isopropanolamine, triethanolamine, triethylenediamine, N,N-dimethylformamide, acetone, methyl ethyl ketone, cyclohexanone, benzene, toluene, xylene, chloroform, 1,2-dichloroethane, 1,2-dichloropropane, 1,1,2-trichloroethane, 1,1,1-trichloroethane, trichloroethylene, tetrachloroethane, dichloromethane, tetrahydrofuran, dioxane, methyl alcohol, ethyl alcohol, isopropyl alcohol, ethyl acetate, butyl acetate, dimethyl sulfoxide, and methyl Cellosolve. These solvents may be used alone or as a mixture of two or more thereof.

### <Methods of Forming Photosensitive Layer>

For forming a photosensitive layer through coating-fluid application, use can be made of any of coating techniques commonly used for forming the photosensitive layers of electrophotographic photoreceptors, such as spray coating, bar coater coating, blade coating, roll coater coating, wire-wound bar coating, knife coater coating, spiral coating, ring coating, and dip coating. After application of a coating fluid, the coating layer is dried to obtain a photosensitive layer.

Examples of the spray coating include air spraying, airless spraying, electrostatic air spraying, electrostatic airless spraying, rotary atomization type electrostatic spraying, hot spraying, and hot airless spraying. However, when the degree of reduction into fine particles for obtaining an even film thickness, efficiency of adhesion, etc. are taken into account, it is preferred to use rotary atomization type electrostatic spraying in which the conveyance method disclosed in Domestic Re-publication of PCT Patent Application No. 1-805198, i.e., a method in which cylindrical works are successively conveyed while rotating these without spacing these in the axial direction, is used. Thus, electrophotographic photoreceptors having excellent evenness in film thickness can be obtained while attaining a comprehensively high degree of adhesion.

As the spiral coating, use may be made of, for example, the method employing a cast coater or curtain coater disclosed in JP-A-52-119651, the method in which a coating material is continuously ejected in a streak form through a minute opening as disclosed in JP-A-1-231966, or the method employing a multinozzle head as discharged in JP-A-3-193161.

An example of the dip coating is the following procedure for forming a charge-transporting layer through coating fluid application. A charge-transporting substance, a binder resin, a solvent, etc. are used to prepare a coating fluid for charge-transporting layer formation having a total solid concentration of preferably 15% by mass or higher and especially preferably 40% by mass or lower and having a viscosity which is preferably 50 mPa·s or higher, especially preferably 100 mPa×s or higher, and is preferably 700 mPa×s or lower, especially preferably 500 mPa×s or lower.

The viscosity of the coating fluid is governed substantially by the molecular weight of the binder resin. However, too low molecular weights result in a photosensitive layer having reduced mechanical strength as stated above. It is therefore preferred to use a binder resin having a molecular weight which is high in such a degree as not to impair the mechanical strength. The coating fluid thus prepared is used to form a charge-transporting layer or photosensitive layer by dip coating. The polymer of the invention is excellent especially in applicability.

Thereafter, the coating film is dried. The drying temperature and drying period are regulated so as to conduct necessary and sufficient drying. The drying temperature is in the range of generally 100-250° C., preferably 110-170° C., more preferably 115-140° C. Examples of drying techniques include drying with a hot-air drying oven, steam dryer, infrared dryer, or far-infrared dryer.

Embodiments of the polymerization toner to be used in the invention, processes for producing the toner, etc. will be explained below.

The electrophotographic photoreceptor of the invention described above is for developing with a polymerization toner an electrostatic latent image formed in the electrophotographic photoreceptor. A polymerization toner has a small particle diameter and a nearby spherical particle shape although satisfactory in resolution. Because of this, a cleaning member should be brought into heavy contact with the electrophotographic photosensitive layer. Consequently, the effects of the invention are produced only when the toner is used in combination with the photosensitive layer containing the specific polymer described above. In addition, since a polymerization toner has a small average particle diameter and a narrow particle diameter distribution and hence gives images which are of satisfactory quality but are apt to have conspicuous image defects as a result of repetitions of use, a higher synergistic effect can be produced by using the toner in combination with the specific electrophotographic photoreceptor described above.

The polymerization toner for use in the invention includes one obtained by the emulsion polymerization aggregation method and one obtained by the suspension polymerization method. Furthermore, an encapsulated toner such as that which will be described later is also included. Preferred is one obtained by the emulsion polymerization aggregation method because of, e.g., the narrow particle diameter distribution thereof.

The volume-average particle diameter (hereinafter abbreviated to “Dv”) of the toner particles to be used in the invention is preferably in the range of 3-15 μm, especially in the range of 4-10 μm. When the volume-average particle diameter thereof is too large, there are cases where high-resolution images are not formed. When the volume-average particle diameter thereof is too small, there are cases where this toner as a powder is difficult to handle. Since the effects of the invention are enhanced when satisfactory resolution is obtained and image defects are apt to be conspicuous, the volume-average particle diameter of the toner is more preferably in the range of 4-8 μm, especially preferably 4-7 μm.

The particle size distribution of the polymerization toner for use in the invention is not particularly limited. However, the value obtained by dividing the Dv by the number-average particle diameter (hereinafter abbreviated to “Dn”), Dv/Dn, is preferably 1.3 or smaller, especially preferably 1.25 or smaller, even more preferably 1.2 or smaller. Although the lower limit of Dv/Dn is 1, this value means that all the particles have the same particle diameter. Such toner particles are difficult to produce or the production is too costly. Consequently, the value of Dv/Dn is preferably 1.03 or larger, more preferably 1.05 or larger.

The volume-average particle diameter Dv and number-average particle diameter Dn of the toner to be used in the invention are defined as the respective particle diameters determined with precision particle size distribution analyzer Coulter Counter Multisizer III, manufactured by Beckman Coulter, Inc. Specifically, the analyzer is used together with an interface for outputting a number distribution and volume distribution and a general personal computer both connected to the analyzer. As an electrolytic solution, Isoton II (manufactured by Beckman Coulter, Inc.) is used. The measuring method is as follows. To 100-150 mL of the electrolytic solution is added 0.1-5 mL of an alkylbenzenesulfonic acid salt as a dispersant. Thereto is added 2-20 mg of a test sample (toner). The electrolytic solution containing the sample suspended therein is treated with an ultrasonic disperser for about 1-3 minutes to disperse the sample. This dispersion is examined with the Coulter Counter Multisizer III using a 100-μm aperture. Thus, the numbers and volumes of the toner particles are determined, and a number-average distribution and a volume-average distribution are calculated. The volume-average particle diameter Dv and the number-average particle diameter Dn are respectively determined from these distributions. In the invention, Dv and Dn are defined as values determined in the manner described above.

The toner preferably is one which has a low content of minute particles (fine particles) and coarse particles. In the case where the content of fine particles is low, this toner has improved flowability and the colorant, charge control agent, and other ingredients are apt to be evenly distributed, resulting in evenness in electrification characteristics. In the invention, examinations of fine particles and coarse particles are made with flow type particle image analyzer FPIA-2000, manufactured by Sysmex Corp. The values of the number, etc. are defined as ones obtained with this apparatus.

In the invention, it is preferred to use a toner in which the found value of the proportion (by number) of particles of 0.6-2.12 μm as determined with that apparatus is 15% or lower based on all particles. This means that the proportion of such fine particles is less than a given amount. The proportion thereof is especially preferably 10% or lower, more preferably 5% or lower. The lower limit of the found value of the proportion (by number) of particles of 0.6-2.12 μm is not particularly limited. Although complete absence thereof is most preferred, to produce such a toner is difficult or too costly. Consequently, the found value of the proportion thereof is preferably 0.5% or higher, especially preferably 1% or higher. When the proportion of those fine particles is within that range, the effects of the image-forming method employing the photosensitive layer according to the invention are produced.

The degree of sphericity of the polymerization toner for use in the invention is not particularly limited. However, a toner made up of nearly spherical toner particles is preferred. In the invention, values of “50% degree of circularity” and “SF-1”, the definitions of which are as follows, are used as measures of the degree of sphericity.

### <50% Degree of Circularity>

The “50% degree of circularity” of a polymerization toner expresses the degree of shape irregularity of the toner particles. It is defined by the following equation and calculated from found values measured with flow type particle image analyzer FPIA-2000, manufactured by Sysmex Corp.

50% degree of circularity=(periphery length of circle having the same area as projected particle area)/(periphery length of projected particle image)

When the toner particles are completely spherical, the value of “50% degree of circularity” is 1. The more the surface shape of the toner particles becomes complicated, the smaller the value of “50% degree of circularity”.

A specific method of measurement is as follows. An alkylbenzenesulfonic acid salt is added as a dispersant to 20 mL of water which is placed in a vessel and from which impurities have been removed beforehand. Thereto is added about 0.05 g of a test sample (toner). An ultrasonic wave was propagated for 30 seconds to the resultant suspension containing the sample dispersed therein to thereby prepare a dispersion having a concentration of 3.0×10³-8.0×10³ particles per μL. This dispersion is examined with the flow type particle image analyzer to determine a roundness distribution of particles having an equivalent-circle diameter of 0.60-160 μm, excluding 160 μm.

The “50% degree of circularity” of the polymerization toner in the invention is not particularly limited. However, it is preferably 0.9 or higher, especially preferably 0.92 or higher, more preferably 0.95 or higher. In view of difficulties in producing complete spheres and of the cost thereof, the 50% degree of circularity of the toner is preferably 0.995 or lower, especially preferably 0.99 or lower. The closer the shape of toner particles to a sphere, the more the toner is preferred from the standpoint of heightening image quality. This is because spherical particles are less apt to have unevenness in charge amount in each particle and tend to have evenness in developing ability. However, in case where the toner particle shape is too close to a complete sphere, it is difficult to remove the residual toner after image formation. There is hence a possibility that toner particles might remain on the surface of the electrophotographic photoreceptor and foul images formed thereafter to cause defects. In such cases, it is necessary to conduct powerful cleaning so as to prevent cleaning failures and this leads to a possibility that the electrophotographic photoreceptor is apt to be worn or marred due to the powerful cleaning, resulting in a shortened life of the electrophotographic photoreceptor.

When the 50% degree of circularity of the polymerization toner is too low, this toner has relatively satisfactory removability in cleaning and, hence, there is no need of bringing a cleaning member into heavy contact with the electrophotographic photoreceptor. There are hence cases where the effects of using the photosensitive layer employing the polymer of the invention cannot be produced.

### <SF-1>

The “SF-1” of a polymerization toner expresses the degree of roundness of the toner particles. The toner is examined with a scanning electron microscope (SEM) to take photographs of each particle at a magnification of 1,000 diameters from different viewing angles. The images of randomly selected 100 toner particles are analyzed with Luzex-F (manufactured by Nireco Corp.). SF-1 is defined as the value calculated using the following equation.

SF-1=((length of maximum particle diameter of projected particle image)²/(projected particle area))×(π/4)×100

When the toner particles are completely spherical, the value of SF-1 is 100. The more the shape of the toner particles become distorted, the larger the value of SF-1.

The SF-1 of the polymerization toner in the invention is not particularly limited. However, it is preferably 140 or smaller, especially preferably 120 or smaller. The smaller the value of SF-1, the less each particle has unevenness in charge amount and the more the developing ability is even. Values of SF-1 in that range are preferred because this toner has a relatively smooth surface and more improved electrification characteristics and higher effects are obtained in attaining the object of the invention. When the value of SF-1 is too large, this toner has relatively satisfactory removability in cleaning and, hence, there is no need of bringing a cleaning member into heavy contact with the electrophotographic photoreceptor. There are hence cases where the effects of using the photosensitive layer according to the invention cannot be produced.

The polymerization toner to be used in the invention can be any of a black toner, a color toner, and full-color toners. However, when a color toner or full-color toners are used, the effects of the invention can be produced more remarkably. Furthermore, the polymerization toner to be used in the invention may be any of a nonmagnetic one-component toner for development, a magnetic one-component toner for development, and a two-component toner for development. It is, however, preferred that the polymerization toner be a nonmagnetic one-component toner for development because use of this toner enables the effects of the invention to be produced remarkably.

### <Emulsion Polymerization Aggregation Method>

One embodiment of the polymerization toner for use in the invention is obtained by the emulsion polymerization aggregation method. The emulsion polymerization aggregation method is not particularly limited as long as it is a method in which particles obtained by emulsion polymerization are aggregated to produce a toner. However, a preferred method comprises: emulsifying one or more polymerizable monomers for constituting primary polymer particles in an aqueous medium containing a polymerization initiator and an emulsifying agent; polymerizing the polymerizable monomers with stirring to first prepare an emulsion of primary polymer particles; subsequently adding a colorant optionally together with ingredients such as a charge control agent and a release agent to the emulsion of primary polymer particles obtained; aggregating the primary polymer particles to form aggregates of the primary particles; and then aging the primary-particle aggregates to thereby produce the target toner.

The polymerizable monomers for constituting primary polymer particles are not particularly limited. Examples thereof include styrene compounds such as styrene, methylstyrene, chlorostyrene, dichlorostyrene, p-tert-butylstyrene, p-n-butylstyrene, and p-n-nonylstyrene; (meth) acrylic esters such as methyl acrylate, ethyl acrylate, propyl acrylate, n-butyl acrylate, isobutyl acrylate, hydroxyethyl acrylate, ethylhexyl acrylate, methyl methacrylate, ethyl methacrylate, propyl methacrylate, n-butyl methacrylate, isobutyl methacrylate, hydroxyethyl methacrylate, and ethylhexyl methacrylate; and acrylamide compounds such as acrylamide, N-propylacrylamide, N,N-dimethylacrylamide, N,N-dipropylacrylamide, and N,N-dibutylacrylamide. Especially preferred of these are styrene, butyl acrylate, and the like. These polymerizable monomers may be used alone or as a mixture of two or more thereof.

A polyfunctional monomer can also be used as a polymerizable monomer for constituting primary polymer particles. Examples of the polyfunctional monomer include divinylbenzene, hexanediol diacrylate, ethylene glycol dimethacrylate, diethylene glycol dimethacrylate, diethylene glycol diacrylate, triethylene glycol diacrylate, neopentyl glycol dimethacrylate, neopentyl glycol acrylate, and diallyl phthalate. It is also possible to use a monomer having a reactive group in a pendant group, such as glycidyl methacrylate, methylolacrylamide, or acrolein. Preferred of these are the radical-polymerizable bifunctional monomers. Especially preferred are divinylbenzene and hexanediol diacrylate. These polyfunctional monomers may be used alone or as a mixture of two or more thereof.

In the case where a polyfunctional monomer is used as one of the polymerizable monomers for constituting primary polymer particles, the content thereof is preferably 0.005 parts by weight or higher, more preferably 0.1 part by weight or higher, even more preferably 0.3 parts by weight or higher, and is preferably 5 parts by weight or lower, more preferably 3 parts by weight or lower, even more preferably 1 part by weight or lower, per 100 parts by weight of all monomers for constituting primary polymer particles. There are cases where the use of a polyfunctional monomer in such an amount improves unsusceptibility to offset to the heating/fixing roller during fixing.

Examples of the polymerization initiator include persulfates such as sodium persulfate and ammonium persulfate; organic peroxides such as t-butyl hydroperoxide, cumene hydroperoxide, and p-menthane hydroperoxide; and inorganic peroxides such as hydrogen peroxide. These may be used alone or as a mixture of two or more thereof. Preferred of these are in organic peroxides. The polymerization initiator is used generally in an amount of 0.05-2 parts by weight per 100 parts by weight of the polymerizable monomers. Furthermore, a redox initiator comprising a combination of any of those polymerization initiators and one or more members selected from reducing organic compounds such as ascorbic acid, tartaric acid, and citric acid and reducing inorganic compounds such as sodium thiosulfate, sodium bisulfite, and sodium metabisulfite can also be advantageously used.

According to need, a known chain transfer agent may be used. Examples thereof include t-dodecyl mercaptan, 2-mercaptoethanol, diisopropyl xanthogen, carbon tetrachloride, and trichlorobromomethane. Such chain transfer agents may be used alone or in combination of two or more thereof, generally in an amount up to 5% by mass based on all monomers.

As the emulsifying agent is generally used a nonionic, anionic, cationic, or amphoteric surfactant. Examples of the nonionic surfactant include polyoxyalkylene alkyl ethers such as polyoxyethylene lauryl ether, polyoxyalkylene alkylphenyl ethers such as polyoxyethylene octylphenyl ether, and sorbitan/fatty acid esters such as sorbitan monolaurate. Examples of the anionic surfactant include fatty acid salts such as sodium stearate and sodium oleate, alkylarylsulfonic acid salts such as sodium dodecylbenzenesulfonate, and sulfuric acid alkyl ester salts such as sodium lauryl sulfate. Examples of the cationic surfactant include alkylamines such as laurylamine acetate and quaternary ammonium salts such as lauryltrimethylammonium chloride. Examples of the amphoteric surfactant include alkylbetaines such as laurylbetaines. One or more of these may be used. Preferred of these are nonionic surfactants and anionic surfactants. The amount of the emulsifying agent to be used is generally 1-10 parts by weight per 100 parts by weight of the polymerizable monomers. One or more of poly(vinyl alcohol) compounds such as, e.g., partly or wholly saponified poly(vinyl alcohol)s and cellulose derivatives such as hydroxyethyl cellulose can be used as a protective colloid in combination with those emulsifying agents.

The addition of the polymerizable monomers to a reaction system in emulsion polymerization may be any of en bloc addition, continuous addition, and intermittent addition. However, continuous addition is preferred from the standpoint of reaction control. In the case where two or more monomers are used, the monomers may be separately added or may be simultaneously added as a mixture thereof prepared beforehand. It is also possible to change the monomer composition during monomer addition. With respect to the addition of the emulsifying agent to the reaction system also, it may be any of en bloc addition, continuous addition, and intermittent addition.

Besides the emulsifying agent and polymerization initiator, other ingredients such as, e.g., a pH regulator, polymerization degree regulator, and antifoamer can be suitably added to the reaction system.

The primary polymer particles may be one kind of primary polymer particles obtained in the manner described above or may comprise a combination of two or more kinds of primary polymer particles obtained in the manner described above. Furthermore, the primary polymer particles may comprise a combination of ones obtained by the emulsion polymerization and particles obtained by another polymerization method. Examples of such particles include particles having the same composition as those obtained by the emulsion polymerization and particles made of: a homopolymer or copolymer of one or more of vinyl monomers such as vinyl acetate, vinyl chloride, vinyl alcohol, vinyl butyral, and vinylpyrrolidone; a thermoplastic resin such as a saturated polyester resin, polycarbonate resin, polyamide resin, polyolefin resin, polyarylate resin, polysulfone resin, or poly(phenylene ether) resin; a thermosetting resin such as an unsaturated polyester resin, phenolic resin, epoxy resin, urethane resin, or rosin-modified maleic acid resin; or the like. Two or more of these particulate materials may be used in combination.

It is desirable that the volume-average particle diameter of the primary polymer particles be generally 0.02 μm or larger, preferably 0.05 μm or larger, more preferably 0.1 μm or larger, and be generally 3 μm or smaller, preferably 2 μm or smaller, more preferably 1 μm or smaller. The volume-average particle diameter is determined with Microtrac UPA, manufactured by Nikkiso Co., Ltd. When the particle diameter thereof is smaller than the above range, there are cases where the rate of aggregation is difficult to regulate. When the diameter thereof exceeds the above range, there are cases where the toner to be obtained through aggregation is apt to have too large a diameter and it is difficult to obtain a toner having a target particle diameter.

The volume particle size distribution, including the volume-average particle diameter, of the primary polymer particles is determined by the dynamic light scattering method. In this method, the speed of the Brownian movement of finely dispersed particles is determined by irradiating the particles with a laser light and detecting the scattering of lights differing in phase according to the speed (Doppler shift) to determine the particle size distribution. An actual examination for determining the volume-average particle diameter is made with a particle size distribution analyzer for ultrafine particles (UPA-EX150, manufactured by Nikkiso Co., Ltd.; abbreviated to “UPA”), which operates by the dynamic light scattering method, under the following conditions.

Upper limit of measurement: 6.54 μm

Lower limit of measurement: 0.0008 μm

Number of channels: 52

Examination period: 100 sec

Particle transparency: absorption

Refractive index of particle: N/A (not applied)

Particle shape: non-spherical

Density: 1 g/cm³

Kind of dispersion medium: water

Refractive index of dispersion medium: 1.333

Before being examined, a dispersion of particles is diluted with a liquid medium so as to result in a sample concentration index in the range of 0.01-0.1. The dispersion diluted is subjected to a dispersing treatment with an ultrasonic cleaner and the resultant sample is examined. The volume-average particle diameter according to the invention is determined by obtaining the arithmetic average of results concerning the volume particle size distribution.

The primary polymer particles have a glass transition temperature which is preferably 40° C. or higher, more preferably 50° C. or higher and is preferably 80° C. or lower, more preferably 70° C. or lower. Glass transition temperatures thereof in that range are desirable because such primary polymer particles give a tone satisfactory in storability and fixability. The glass transition temperature can be determined from a curve obtained through an examination with a differential scanning calorimeter (DTA-40, manufactured by Shimadzu Corp.) under the conditions of a heating rate of 10° C./min. Specifically, a tangent is drawn to the curve at each of the transition (inflection) initiation points, and the temperature corresponding to the intersection of the two tangents is taken as the glass transition temperature.

The primary polymer particles desirably have such a molecular weight distribution that at least one of the peak molecular weights measured by gel permeation chromatography is preferably 3,000 or higher, more preferably 10,000 or higher, even more preferably 30,000 or higher and is preferably 100,000 or lower, more preferably 70,000 or lower, even more preferably or lower. Primary polymer particles having a peak molecular weight within that range are preferred because such primary particles give a toner satisfactory in durability, storability, and fixability. The peak molecular weight is a value calculated for standard polystyrene, and all ingredients insoluble in the solvent are removed before the examination.

The colorant also is not limited, and use may be made of various inorganic and organic dyes, pigments, and the like in common use as colorants for toners. Examples thereof include metal powders such as iron powders and copper powders; metal oxides such as red iron oxide; inorganic pigments such as carbons represented by carbon blacks such as furnace black and lamp black; and acid dyes and basic dyes, such as precipitates of dyes, e.g., azo compounds such as Benzidine Yellow and Benzidine Orange, Quinoline Yellow, Acid Green, and Alkali Blue, with a precipitant and precipitates of dyes, e.g., Rhodamine, Magenta, and Malachite Green, with tannic acid, molybdic acid, or the like, mordant dyes such as metal salts of hydroxyanthraquinone compounds, organic pigments such as phthalocyanine compounds, e.g., Phthalocyanine Blue and copper sulfonate phthalocyanines, quinacridone compounds, e.g., Quinacridone Red and Quinacridone Violet, and dioxane compounds, and synthetic dyes such as Aniline Black, azo dyes, naphthoquinone dyes, indigo dyes, Nigrosine dyes, phthalocyanine dyes, polymethine dyes, and di- and triarylmethane dyes. Two or more of these may be used in combination. The content of the colorant is preferably 1-20 parts by weight, especially preferably 2-15 parts by weight, per 100 parts by weight of the primary polymer particles.

A colorant having magnetic properties may be used in the toner for use in the invention as long as this does not impair the properties of the toner. Examples of the magnetic colorant include ferromagnetic substances which show ferrimagnetism or ferromagnetism at around 0-60° C., at which copiers and the like are used. Specific examples thereof include magnetite (Fe₃O₄), maghematite (γ-Fe₂O₃), and intermediates for and mixtures of magnetite and maghematite; spinel ferrites such as ferrites (MₓFe₃₋ₓO₄, wherein M is Mg, Mn, Fe, Co, Ni, Cu, Zn, Cd, etc.); hexagonal ferrites such as BaO×6Fe₂O₃ and SrO×6Fe₂O₃; garnet-form oxides such as Y₃Fe₅O₁₂ and Sm₃Fe₅O₁₂; rutile-form oxides such as CrO₂; and metals such as Cr, Mn, Fe, Co, and Ni and ferromagnetic alloys thereof which show magnetism at around 0-60° C. Preferred of these are magnetite and the like. In the case where a magnetic colorant is incorporated from the standpoints of dusting prevention, charge control, etc. while maintaining properties of a nonmagnetic toner, it is desirable that the amount of the magnetic colorant to be incorporated be 0.1-10 parts by weight, preferably 0.2-8 parts by weight, more preferably 0.5-5 parts by weight, per 100 parts by weight of the primary polymer particles.

It is preferred that the polymerization toner to be used in the invention should contain a charge control agent. Examples of the charge control agent include known positive charge type charge control agents such as Nigrosine dyes, quaternary ammonium salt compounds, triphenylmethane compounds, imidazole compounds, and polyamine resins. Examples thereof further include negative charge type charge control agents such as azo dyes containing a metal, e.g., chromium, cobalt, aluminum, or iron; salts or complexes of salicyclic acid or alkylsalicyclic acids with a metal, e.g., chromium, zinc, or aluminum; metal salts or metal complexes of benzilic acid; and amide compounds, phenol compounds, naphthol compounds, and phenolamide compounds. The content of the charge control agent is preferably 0.01-10 parts by weight, more preferably 0.1-5 parts by weight, per 100 parts by weight of the primary polymer particles.

It is preferred that the polymerization toner to be used in the invention should further contain a release agent so as to have, e.g., improved releasability in fixing to a receiving material. Examples of the release agent include known waxes. Specific examples thereof include polyolefin waxes such as low-molecular polyethylene, low-molecular polypropylene, and low-molecular ethylene/propylene copolymers; fluororesin waxes such as low-molecular polytetrafluoroethylene; paraffin waxes; ester waxes having a long-chain aliphatic group, such as stearic esters, behenic esters, and montanic esters; vegetable waxes such as hydrogenated castor oil and carnauba wax; ketones having long-chain alkyl groups, such as distearyl ketone; silicones having an alkyl group; higher fatty acids such as stearic acid; long-chain aliphatic alcohols; (partial) esters of a polyhydric alcohol, e.g., pentaerythritol, with a long-chain fatty acid; and higher fatty acid amides such as oleamide and stearamide. Of these release agents for use in the invention, ones having a melting point of 50-100° C. are preferred from the standpoints of low-temperature fixing and high-speed fixing.

The release agent may be used as seeds in the emulsion polymerization of the polymerizable monomers to conduct seed polymerization and thereby produce primary polymer particles containing the release agent. The content of the release agent is preferably 0.1-30 parts by weight, more preferably 5-25 parts by weight, per 100 parts by weight of the primary polymer particles.

Furthermore, the toner may contain various known internal additives, such as, e.g., a silicone oil and a silicone varnish, so as to be improved in tackiness, cohesiveness, flowability, electrification characteristics, surface resistance, etc. Although such additives can be incorporated in toner particles by adding these during aggregation, it is preferred that the additives should have been incorporated beforehand in primary polymer particles.

The production of toner particles by the emulsion polymerization aggregation method can be accomplished in the following manner. A colorant is added optionally together with additives such as a charge control agent and a release agent to the emulsion of primary polymer particles obtained by the emulsion polymerization. The dispersion stability of the emulsified primary polymer particles is then reduced, for example, by heating, electrolyte addition, pH regulation, or hardener addition while stirring/mixing the emulsion with a disperser, mixer, or the like. Thus, a treatment for aggregating the primary particles is performed to obtain aggregates. Subsequently, a heat treatment is conducted to age (fusion-bond) the primary particles in each aggregate to one another and stabilize the aggregates.

In the case where aggregation is conducted by adding an electrolyte, the electrolyte may be either an organic salt or an inorganic salt. Examples thereof include NaCl, KCl, LiCl, Na₂SO₄, K₂SO₄, Li₂SO₄, MgCl₂, CaCl₂, MgSO₄, CaSO₄, ZnSO₄, Al₂(SO₄)₃, Fe₂(SO₄)₃, CH₃COONa, and C₆H₅SO₃Na. Preferred of these are the inorganic salts having one or more polyvalent metal cations having a valence of 2 or higher. The amount of the electrolyte to be added varies depending on the kind of the electrolyte. However, the amount thereof is generally 0.05-25 parts by weight, preferably 0.1-15 parts by weight, more preferably 0.1-10 parts by weight, per 100 parts by weight of the solid components of the mixture dispersion. In case where the amount of the electrolyte added for conducting aggregation is smaller than the above range, the progress of an aggregation reaction is slow and this may pose problems, for example, that the product of the aggregation reaction contains residual fine particles of 1 μm or smaller and the average particle diameter of the particle aggregates obtained is smaller than a target particle diameter. In case where the amount thereof exceeds the above range, the primary polymer particles are apt to rapidly aggregate and particle diameter regulation is difficult. There are hence cases where this aggregation poses a problem, for example, that the aggregates obtained include coarse particles and particles of irregular shapes. When an electrolyte is added to conduct aggregation, the aggregation temperature is preferably 20-40° C., more preferably 25-35° C.

When the primary particles in each aggregate are fusion-bonded to one another and stabilized, the heating temperature preferably is not lower than the glass transition temperature of the polymer constituting the primary particles, and more preferably is higher than the glass transition temperature by 5° C. or more. Furthermore, the heating temperature preferably is not higher than the temperature higher by 80° C. than the glass transition temperature, and more preferably is not higher than the temperature higher by 50° C. than the glass transition temperature. The heating period is preferably 1-6 hours. Through this heat treatment, the primary particles in each aggregate are fusion-bonded and united to each other and the toner particles as aggregates become nearly spherical.

### <Suspension Polymerization Method>

Another embodiment of the polymerization toner for use in the invention is obtained by the suspension polymerization method. The suspension polymerization method is not particularly limited as long as it is a method in which toner particles are directly obtained by suspension polymerization. Examples thereof include the method described in, e.g., JP-A-10-269501.

In the suspension polymerization method, a polymerization initiator, colorant, charge control agent, release agent, etc. are added to one or more polymerizable monomers and the resultant mixture is subjected to a dispersing treatment with a dispersing machine such as a disperser. This liquid which has undergone the dispersing treatment is treated with an appropriate stirrer in a water-miscible medium to thereby form that liquid into droplets having a toner particle diameter. Thereafter, the polymerizable monomers are polymerized to produce a toner.

The polymerizable monomers and other ingredients usable in the suspension polymerization method, such as an acid monomer, basic monomer, polyfunctional monomer, chain transfer agent, colorant, colorant having magnetic properties, charge control agent, and release agent, may be the same as those used in the emulsion polymerization aggregation method described above. Preferred examples thereof also are the same as those shown above. Furthermore, the preferred ranges of contents and the like also are the same.

When a suspension stabilizer is to be used in producing a toner by the suspension polymerization method, it is preferred to select a suspension stabilizer which is neutral or alkaline in water and can be easily removed by washing the toner with an acid after the polymerization. It is also preferred to select one with which a toner having a narrow particle size distribution is obtained. Examples of suspension stabilizers satisfying these requirements include calcium phosphate, tricalcium phosphate, magnesium phosphate, calcium hydroxide, and magnesium hydroxide. These may be used alone or in combination of two or more thereof. These suspension stabilizers can be used in an amount in the range of 1-10 parts by weight per all polymerizable monomers.

Examples of the polymerization initiator for use in the suspension polymerization method include the same initiators as those for use in the emulsion polymerization aggregation method described above. Besides those, examples thereof further include 2,2′-azobisisobutyronitrile, 2,2′-azobisiso(2,4-dimethyl)valeronitrile, benzoyl peroxide, and lauroyl peroxide. Preferred of these in the suspension polymerization method are the azo polymerization initiators.

<Matters Common between Emulsion Polymerization Aggregation Method and Suspension Polymerization Method>

As stated hereinabove, the toner particles obtained by the emulsion polymerization aggregation method and the toner particles obtained by the suspension polymerization method may be converted to a toner having a capsule structure by coating the toner particle surface with a polymer, polymer emulsion, colorant dispersion, charge control agent dispersion, wax dispersion, or the like to thereby form an outer layer. Although the thickness of the outer layer in this case is not particularly limited, it is preferably 0.01-0.5 μm. The glass transition temperature of the polymer or emulsion polymer for use as the outer layer is preferably in the range of 70-110° C. and is preferably higher than the glass transition temperature of the toner particles. It is preferred that the outer layer be formed by a technique such as the spray drying method, in-situ method, or in-liquid particle-coating method.

The polymerization toner to be used in the invention is one which comprises toner particles and external-additive fine particles deposited on the surface of the toner particles. As the external-additive fine particles, known inorganic or organic fine particles can be used. The fine particles may be either ones of the negative electrification type or ones of the positive electrification type. A combination of these may also be used.

Examples of the external-additive fine particles of the negative electrification type include the following inorganic fine particles: metal oxides and hydroxides such as alumina, silica, titania, zinc oxide, zirconium oxide, cerium oxide, talc, and hydrotalcite; titanic acid metal salts such as calcium titanate, strontium titanate, and barium titanate; nitrides such as titanium nitride and silicon nitride; and carbides such as titanium carbide and silicon carbide. Examples thereof further include organic fine particles made of acrylic acid resins produced from one or more monomers comprising acrylic acid or a derivative thereof as the main component, methacrylic acid resins produced from one or more monomers comprising methacrylic acid or a derivative thereof as the main component, tetrafluoroethylene resins, trifluoroethylene resins, poly(vinyl chloride), polyethylene, and polyacrylonitrile. Preferred of those inorganic finely particulate materials are silica, titania, alumina, and the like. More preferred are ones which have undergone a surface treatment with, e.g., a silane coupling agent or a silicone oil. Preferred of those organic finely particulate materials are acrylic acid resins such as poly(methyl acrylate) and methacrylic acid resins such as poly(methyl methacrylate). Especially preferred is poly(methyl methacrylate).

Examples of the external-additive fine particles of the positive electrification type include calcium phosphate compounds such as tricalcium phosphate, calcium dihydrogen phosphate, calcium monohydrogen phosphate, and substituted calcium phosphates in which the phosphate ions have been partly replaced by an anion; such calcium phosphate compounds whose surfaces have undergone a hydrophobizing treatment with, e.g., a fatty acid; and silica and alumina which have undergone a surface treatment such as an aminosilane treatment.

The external-additive fine particles desirably are ones having an average particle diameter which is preferably 0.001 μm or larger, more preferably 0.005 μm or larger, and is preferably 1 μm or smaller, more preferably 0.5 μm or smaller. It is also possible to incorporate two or more finely particulate external additives differing in material or average particle diameter.

The content of the external-additive fine particles is 0.5% by mass or higher, preferably 1% by mass or higher, more preferably 1.5% by mass or higher, and is 3.5% by mass or lower, preferably 3% by mass or lower, more preferably 2.5% by mass or lower, based on the toner to be finally obtained. By depositing external-additive fine particles on the surface of the toner particles in such an amount as to result in that content, low-temperature fixability and non-offset properties are improved to make high-speed printing possible. Although the mechanism by which these effects are brought about has not been elucidated, the reason for the effects is presumed to be that the external-additive fine particles do not physically inhibit the toner in a molten state from adhering to a printing paper or the like, as long as the amount of the external-additive fine particles deposited is within the range shown above.

It is further thought that the efficiency of heat transfer from the heating roller to the tone during fixing can be inhibited from decreasing by regulating the external-additive fine particles so as not to be deposited in an excess amount, and that the toner can hence melt rapidly and be satisfactorily fixed even under high-speed printing conditions including a printing speed of, e.g., 100 mm/sec or higher, especially 200 mm/sec or higher. In case where the content of the external-additive fine particles is lower than the above range, this toner has impaired flowability to cause image defects such as insufficient toner transfer in solid images. The term “content of external-additive fine particles” means the content of not only the external-additive fine particles adherent to the surface of the toner particles but also the external-additive fine particles which are not adherent to the toner particles and are present independently and the external-additive fine particles embedded in surface parts of the toner particles.

Methods for incorporating (adhering) the external-additive fine particles to the surface of the toner particles are not limited, and a mixing machine in general use for toner production can be used. For example, the incorporation is accomplished by evenly mixing the toner particles with the external-additive fine particles with stirring with a mixing machine such as, e.g., a Henschel mixer, twin-cylinder mixer, or Redige mixer.

The electrification characteristics of the polymerization toner thus obtained for use in the invention are not limited. In the case where the toner is of the negative electrification type, it is desirable that the charge amount thereof as measured at 23° C. and a relative humidity of 50% be preferably −10 μC/g or smaller, more preferably −20 μC/g or smaller, and be preferably −90 μC/g or larger, more preferably −70 μC/g or larger. In the case where the toner is of the positive electrification type, the charge amount thereof as measured at 23° C. and a relative humidity of 50% be preferably +10 μC/g or larger, more preferably +15 μC/g or larger, and be preferably +50 μC/g or smaller, more preferably +30 μC/g or smaller.

In the invention, the charge amount of a toner is measured in the following manner. First, 19.2 g of a non-coated ferrite carrier (F100, manufactured by Powder Tech Co., Ltd.) and 0.8 g of the particles to be examined are weighed out, and these ingredients are stirred together for 5 minutes with Recipro Shaker (stirring power, 500 rpm). Thereafter, the resultant mixture is examined with a blow-off charge measurement apparatus (manufactured by Toshiba Chemical Corp.).

When the toner to be used in the invention has a charge amount within that range, use of this toner is preferred because it gives high-quality images reduced in fogging. The charge amount of the toner can be regulated by selecting the resin serving as the main component of the developer and the charge control agent, external-additive fine particles, and other ingredients to be added according to need or by changing the proportions of these ingredients, blending method, or deposition method. In particular, to optimize the selection of external-additive fine particles and the method of depositing the particles is effective.

### <Image-Forming Apparatus>

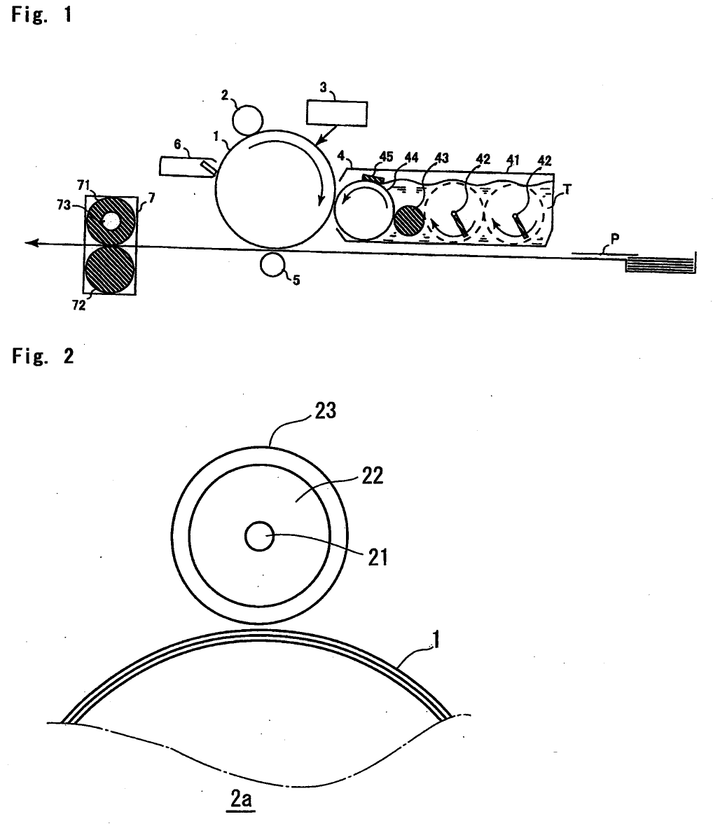

An embodiment of the image-forming apparatus employing the electrophotographic photoreceptor and polymerization toner according to the invention is explained below by reference to FIG. 1, which illustrates the constitution of important parts of the apparatus. However, embodiments of the apparatus should not be construed as being limited to that explained below, and the apparatus can be modified at will as long as the modifications do not depart from the spirit of the invention.

As shown in FIG. 1, the image-forming apparatus comprises an electrophotographic photoreceptor 1, a charging device 2, an exposure device 3, and a developing device 4. The apparatus may further has a transfer device 5, a cleaner 6, and a fixing device 7 according to need.

The electrophotographic photoreceptor 1 is not particularly limited as long as it is the electrophotographic photoreceptor of the invention described above. FIG. 1 shows, as an example thereof, a drum-shaped photoreceptor comprising a cylindrical conductive substrate and, formed on the surface thereof, the photosensitive layer described above. The charging device 2, exposure device 3, developing device 4, transfer device 5, and cleaner 6 have been disposed along the peripheral surface of this electrophotographic photoreceptor 1.

The charging device 2 serves to charge the electrophotographic photoreceptor 1. It evenly charges the surface of the electrophotographic photoreceptor 1 to a given potential. FIG. 1 shows a roller type charging device (charging roller) as an example of the charging device 2. However, corona charging devices such as corotrons and scorotrons, contact type charging devices such as charging brushes, and the like may be used besides the charging rollers. Since the electrophotographic photoreceptor of the invention has excellent durability, it is preferred that the photoreceptor be charged with a contact charging member. Preferred of such contact charging members for use in charging the electrophotographic photoreceptor of the invention is a roller type charging device which has a roller type contact charging member, from the standpoint that this charging device is less apt to wear the electrophotographic photoreceptor. An example of this charging device is shown in FIG. 2.

In many cases, the electrophotographic photoreceptor 1 and the charging device 2 have been designed to constitute a cartridge (hereinafter sometimes referred to as “photoreceptor cartridge”) which involves these two members and is removable from the main body of the image-forming apparatus. In this constitution, when, for example, the electrophotographic photoreceptor 1 and the charging device 2 have deteriorated, this photoreceptor cartridge can be removed from the main body of the image-forming apparatus and a fresh photoreceptor cartridge can be mounted in the main body of the image-forming apparatus. With respect to the toner also, the toner in many cases has been designed to be stored in a toner cartridge and be removable from the main body of the image-forming apparatus. In this constitution, when the toner in the toner cartridge in use has run out, this toner cartridge can be removed from the main body of the image-forming apparatus and a fresh toner cartridge can be mounted. There are also cases where a cartridge containing all of an electrophotographic photoreceptor 1, a charging device 2, and a toner is used.

The exposure device 3 is not particularly limited in kind as long as it can illuminate the electrophotographic photoreceptor 1 and thereby form an electrostatic latent image in the photosensitive surface of the electrophotographic photoreceptor 1. Examples thereof include halogen lamps, fluorescent lamps, lasers such as semiconductor lasers and He—Ne lasers, and LEDs. It is also possible to conduct exposure by the technique of internal photoreceptor exposure. Any desired light can be used for exposure. For example, the monochromatic light having a wavelength of 780 nm, a monochromatic light having a slightly short wavelength of 600-700 nm, a monochromatic light having a short wavelength of 380-500 nm, or the like may be used to conduct exposure.

The developing device 4 is not particularly limited in kind, and any desired device can be used, such as one operated by a dry development technique, e.g., cascade development, development with one-component conductive toner, or two-component magnetic brush development, a wet development technique, etc. Since the electrophotographic photoreceptor of the invention has excellent durability, it produces higher effects when used in combination with a developing device employing a developing roller disposed in contact with the electrophotographic photoreceptor, a magnetic brush which slidingly rubs the surface of the electrophotographic photoreceptor, or the like. In FIG. 1, the developing device 4 comprises a developing chamber 41, agitators 42, a feed roller 43, a developing roller 44, and a control member 45. This device has such a constitution that a toner T is stored in the developing chamber 41. According to need, the developing device 4 may be equipped with a replenishing device (not shown) for replenishing the toner T. This replenishing device has such a constitution that the toner T can be supplied from a container such as a bottle or cartridge.

The feed roller 43 is made of an electrically conductive sponge, etc. The developing roller 44 comprises, for example, a metallic roll made of iron, stainless steel, aluminum, nickel, or the like or a resinous roll obtained by coating such a metallic roll with a silicone resin, urethane resin, fluororesin, or the like. The surface of this developing roller 44 may be subjected to a surface-smoothing processing or surface-roughening processing according to need.

The developing roller 44 is disposed between the electrophotographic photoreceptor 1 and the feed roller 43 and is in contact with each of the electrophotographic photoreceptor 1 and the feed roller 43. The feed roller 43 and the developing roller 44 are rotated by a rotation driving mechanism (not shown). The feed roller 43 holds the toner T stored and supplies it to the developing roller 44. The developing roller 44 holds the toner T supplied by the feed roller 43 and brings it into contact with the surface of the electrophotographic photoreceptor 1.

The control member 45 comprises a resinous blade made of a silicone resin, urethane resin, or the like, a metallic blade made of stainless steel, aluminum, copper, brass, phosphor bronze, or the like, a blade obtained by coating such a metallic blade with a resin, etc. This control member 45 is in contact with the developing roller 44 and is pushed against the developing roller 44 with a spring or the like at a given force (the linear blade pressure is generally 5-500 g/cm). According to need, this control member 45 may have the function of charging the toner T based on electrification by friction with the toner T.

The agitators 42 each are rotated by the rotation driving mechanism. They agitate the toner T and convey the toner T to the feed roller 43 side. Two or more agitators 42 differing in blade shape, size, etc. may be disposed.

The transfer device 5 is not particularly limited in kind, and use can be made of a device operated by any desired technique selected from an electrostatic transfer technique, pressure transfer technique, adhesive transfer technique, and the like, such as corona transfer, roller transfer, and belt transfer. Here, the transfer device 5 is one constituted of a transfer charger, transfer roller, transfer belt, or the like disposed so as to face the electrophotographic photoreceptor 1. A given voltage (transfer voltage) which has the polarity opposite to that of the charge potential of the toner T is applied to the transfer device 5, and this transfer device 5 thus transfers the toner image formed on the electrophotographic photoreceptor 1 to a recording paper (paper or medium) P.

The cleaner 6 serves to scrape off the residual toner adherent to the photoreceptor 1 with a cleaning member and thus recover the residual toner. However, when there is little or no residual toner adherent to the photoreceptor 1, the cleaner 6 may be omitted as long as no influence is exerted on images. The cleaner 6 is not particularly limited, and any desired cleaner can be used, such as a brush cleaner, magnetic brush cleaner, electrostatic brush cleaner, magnetic roller cleaner, or blade cleaner. Since a polymerization toner is used in the invention, the conditions under which the toner is scraped off with the cleaning member are severe and there are cases where an increased load is imposed on the photoreceptor 1.

The fixing device 7 is constituted of an upper fixing member (fixing roller) 71 and a lower fixing member (fixing roller) 72. The fixing member 71 or 72 is equipped with a heater 73 inside. FIG. 1 shows an example in which the upper fixing member 71 is equipped with a heater 73 inside. As the upper and lower fixing members 71 and 72 can be used a known heat-fixing member such as a fixing roll comprising a metallic tube made of stainless steel, aluminum, or the like and a silicone rubber with which the tube is coated, a fixing roll obtained by further coating that fixing roll with a polytetrafluoroethylene resin, or a fixing sheet. Furthermore, the fixing members 71 and 72 each may have a constitution in which a release agent such as a silicone oil is supplied thereto in order to improve release properties, or may have a constitution in which the two members are forcedly pressed against each other with a spring or the like.

The toner which has been transferred to the recording paper P passes through the nip between the upper fixing member 71 heated at a given temperature and the lower fixing member 72, during which the toner is heated to a molten state. After the passing, the toner is cooled and fixed to the receiving paper P.

The fixing device also is not particularly limited in kind. Fixing devices which can be mounted include ones operated by any desired fixing technique, such as heated-roller fixing, flash fixing, oven fixing, or pressure fixing, besides the device used here.

### <Image Recording>

In the image-forming apparatus employing the electrophotographic photoreceptor and having the constitution described above, image recording is conducted in the following manner. First, the surface (photosensitive surface) of the photoreceptor 1 is charged to a given potential (e.g., −600 V) by the charging device 2. This charging may be conducted with a direct-current voltage or with a direct-current voltage on which an alternating-current voltage has been superimposed. However, the charging device 2 preferably is one which charges the photoreceptor with a direct-current voltage because the mechanical vibrations thereof are small. Furthermore, the charging device 2 preferably is one which charges the photoreceptor by contact charging, in particular, roller contact charging, because this charging device enables the effects of the electrophotographic photoreceptor of the invention to be produced more remarkably.

Subsequently, the charged photosensitive surface of the photoreceptor 1 is exposed by the exposure device 3 according to the image to be recorded. Thus, an electrostatic latent image is formed in the photosensitive surface. This electrostatic latent image formed in the photosensitive surface of the photoreceptor 1 is developed by the developing device 4. In the developing device 4, the toner T fed by the feed roller 43 is formed into a thin layer with the control member (developing blade) 45 and, simultaneously therewith, frictionally charged so as to have a given polarity (here, the toner is charged so as to have negative polarity, which is the same as the polarity of the charge potential of the photoreceptor 1). This toner T is conveyed while being held by the developing roller 44 and is brought into contact with the surface of the photoreceptor 1.

When the charged toner T held on the developing roller 44 comes into contact with the surface of the photoreceptor 1, a toner image corresponding to the electrostatic latent image is formed on the photosensitive surface of the photoreceptor 1. This toner image is transferred to a recording paper P by the transfer device 5. Thereafter, the toner which has not been transferred and remains on the photosensitive surface of the photoreceptor 1 is removed by the cleaner 6. After the transfer of the toner image to the recording paper P, this recording paper P is passed through the fixing device 7 to thermally fix the toner image to the recording paper P. Thus, a finished image is obtained.

Incidentally, the image-forming apparatus may have a constitution in which an erase step, for example, can be conducted, in addition to the constitution described above. The erase step is a step in which the electrophotographic photoreceptor is exposed to a light to thereby erase the residual charges from the electrophotographic photoreceptor. As an eraser may be used a fluorescent lamp, LED, or the like. The light to be used in the erase step, in many cases, is a light having such an intensity that the exposure energy thereof is at least 3 times the energy of the exposure light.

The constitution of the image-forming apparatus may be further modified. For example, the apparatus may have a constitution in which steps such as a pre-exposure step and an auxiliary charging step can be conducted, or have a constitution in which offset printing is conducted. Furthermore, the apparatus may have a full-color tandem constitution employing two or more toners.

The mechanism/principle by which the electrophotographic photoreceptor employing a polymer comprising repeating units including the partial structure represented by formula (1) shows excellent durability even when used for development with a polymerization toner has not been elucidated. However, it is thought that the durability is attributable to the stacking structure of molecular chains of the polymer. It is further thought that although the charge-transporting substance contained in a large amount in a compatibilized state generally reduces the strength, that polymer is less influenced by the charge-transporting substance.

### EXAMPLES

The invention will be explained below in more detail by reference to Examples and Comparative Examples. However, the invention should not be construed as being limited to the following Examples unless the invention departs from the spirit thereof. Each “parts” used in the Examples indicates “parts by weight” unless otherwise indicated, and each “%” indicates “% by mass” unless otherwise indicated.

### Example 1

### Production of Photoreceptor Drum A

Ten parts of oxytitanium phthalocyanine which, when examined by X-ray diffraction analysis with CuK_{α} characteristic X-ray, showed a maximum diffraction peak at a Bragg angle (2θ±0.2°) of 27.3° was mixed with 150 parts of 1,2-dimethoxyethane. This mixture was treated with a sand grinding mill for pulverization and dispersion to produce a pigment dispersion. On the other hand, 5 parts of poly(vinyl butyral) (trade name, Denka Butyral #6000C; manufactured by Denki Kagaku Kogyo K.K.) was mixed with 95 parts of 1,2-dimethoxyethane to produce a binder resin solution having a solid concentration of 5%.

160 Parts of the pigment dispersion produced above was mixed with 100 parts of the binder resin solution, an appropriate amount of 1,2-dimethoxyethane, and an appropriate amount of 4-methoxy-4-methyl-2-pentanone to produce a dispersion for charge-generating layer formation through coating. This dispersion had a solid concentration of 4.0% and a (1,2-dimethoxyethane):(4-methoxy-4-methyl-2-pentanone) ratio of 9:1 (by mass).

Subsequently, the surface of an aluminum-alloy cylinder which had an outer diameter of 30 mm, length of 351 mm, and wall thickness of 1.0 mm and the surface of which had been mirror-polished was subjected to anodization and then to a pore-filling treatment with a pore-filling agent containing nickel acetate as the main component. Thus, an anodized coating film (alumite coating) having a thickness of about 6 μm was formed.

This cylinder was then dip-coated with the dispersion for charge-generating layer formation produced above to thereby form a charge-generating layer having a thickness of about 0.4 μm on a dry basis.

Subsequently, this cylinder on which the charge-generating layer had been formed was dip-coated with a coating fluid for charge-transporting layer formation produced by mixing 50 parts of the charge-transporting substance represented by the following formula (a) with 100 parts of a polycarbonate (viscosity-average molecular weight, about 30,000) consisting only of repeating units represented by formula (2) as a binder resin and with a tetrahydrofuran:toluene=80:20 (by mass) mixed solvent. Thus, a charge-transporting layer having a thickness of 18 μm on a dry basis was formed. The dispersion for charge-transporting layer formation through coating had high viscosity stability, and was capable of giving a satisfactory charge-transporting layer free from unevenness, gathering, thickness fluctuations, etc. The coated cylinder thus obtained is referred to as photoreceptor drum A.

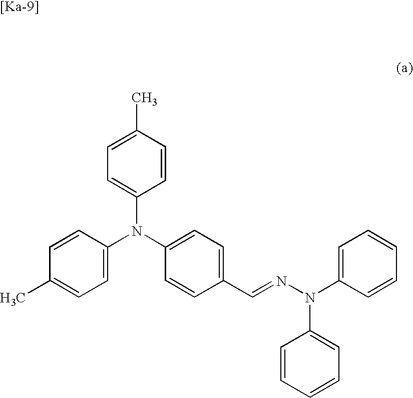

### <Production of Photoreceptor Drum B>

The same procedure as in the production of photoreceptor drum A was conducted, except that the polycarbonate used in producing photoreceptor drum A was replaced by the polycarbonate represented by the following formula (8). Thus, photoreceptor drum B was produced.

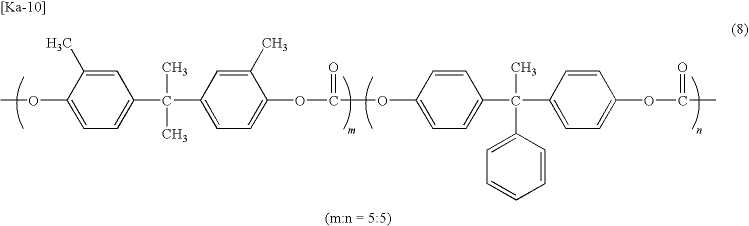

### <Production of Polymerization Toner>

A cyan base toner comprising as the main component a copolymer of styrene and n-butyl acrylate in a molar ratio of 77/23 (peak molecular weight, 3.0×10⁴) produced by the emulsion polymerization aggregation method was mixed in an amount of 1,000 parts with 20 parts of the following silica 1 and 5 parts of the following silica 2 each as external-additive fine particles, by means of a Henschel mixer manufactured by Mitsui Mining Co., Ltd. Thus, a polymerization toner for evaluation was produced.

Silica 1: treated with hexamethyldisilazane; primary-particle diameter, about 30 nm

Silica 2: treated with dimethylpolysiloxane; primary-particle diameter, about 7 nm

The polymerization toner had a Dv of 7.3 μm and a Dn of 6.4 μm. Furthermore, the toner had a 50% degree of circularity of 0.96 and an SF-1 of 136.

### <Production of Pulverization Toner>

Using a binder polymer having the same composition and molecular weight as that used for producing the polymerization toner and using the same coloring pigment and other ingredients as those used for producing the polymerization toner, a pulverization toner was produced in an ordinary manner. This pulverization toner had a Dv of 8.1 μm and a Dn of 6.3 μm, and had a 50% degree of circularity of 0.90 and an SF-1 of 154. This toner had a glass transition temperature of 62.5° C., which was the same as that of the polymerization toner.

### Evaluation Examples 1 to 4

### Image Evaluation with Image-Forming Apparatus

### <<Determination of Value of On-Drum Fogging>>

Photoreceptor drums A to F each was mounted in a cartridge for a commercial printer (ML9300, manufactured by Oki Data Corp.), and the polymerization toner was charged into the cartridge. In an LL (5° C., 10% RH) environment, image formation was conducted on alternate sheets, and 14,000 sheets were thus printed. Every 1,000 sheets after initiation of the image formation, a solid image and a memory ascertainment image were printed. The ML9300 used for evaluation, manufactured by Oki Data Corp., is a tandem type full-color image-forming apparatus equipped with a roller type contact charging member to which a direct-current voltage is applied and which is disposed in contact with the electrophotographic photoreceptor. In this apparatus, the photoreceptor is exposed to an LED light having a wavelength of 760 nm and development is conducted with a developing device having a developing roller disposed in contact with the electrophotographic photoreceptor.

Fogging on the drum was evaluated in the following manner. After printing of a white solid image, a transparent pressure-sensitive adhesive tape was applied to the surface of the photoreceptor drum while preventing air bubbles from being trapped between the photoreceptor drum and the adhesive tape. Thereafter, the tape was stripped off and applied to white paper. Subsequently, the optical density of the transparent pressure-sensitive adhesive tape applied was measured from above with a Macbeth densitometer (RD920, manufactured by Gretag-Macbeth Ltd.). A transparent pressure-sensitive adhesive tape of the same kind was merely applied to white paper, and this tape also was examined for optical density in the same manner. The difference between these two density values was taken as the value of on-drum fogging. After initiation of image formation, this procedure for determining the value of on-drum fogging was conducted every 1,000-sheet printing until completion of 14,000-sheet printing. <<Determination of Memory Value>>

Memory image was evaluated in the following manner. A halftone image was formed and the density (hereinafter referred to as H1) was then measured. Subsequently, a memory ascertainment image (an image including a black solid circle in an upper part thereof, with the background being halftone) was formed, and the density of that part of the image which was located apart from the black solid circle at a distance corresponding to the drum periphery (94.2 mm) was measured (this density is hereinafter referred to as H2). The absolute value of the difference between H1 and H2 was taken as memory value. Like the value of on-drum fogging, the memory value was determined every 1,000-sheet printing after initiation of image formation until completion of the printing of 14,000 sheets at the most. The larger the value of on-drum fogging or the larger the memory value, the poorer the image. When the value shown above (difference between H1 and H2) exceeds 0.05, a distinct difference can be visually recognized.

The polymerization toner and pulverization toner were used to evaluate photoreceptor drum A and photoreceptor drum B. The results thereof are shown in Tables 1 and 2, wherein K represents 1,000.

Results of Image Evaluation with Image-Forming Apparatus (Value of on-Drum Fogging)

TABLE 1

| | | Photo- | | | | | | | | | | | | | | | | |
|---|---|---|---|---|---|---|---|---|---|---|---|---|---|---|---|---|---|---|
| Evaluation | | receptor | Number of sheets printed (alternate sheets) | | | | | | | | | | | | | | | |
| Example | Toner | drum | initial | 0K | 1K | 2K | 3K | 4K | 5K | 6K | 7K | 8K | 9K | 10K | 11K | 12K | 13K | 14K |
| 1 | polymeri- | A | 0.08 | 0.08 | 0.09 | 0.09 | 0.10 | 0.10 | 0.10 | 0.10 | 0.09 | 0.09 | 0.09 | 0.09 | 0.10 | 0.10 | 0.10 | 0.10 |
| | zation | | | | | | | | | | | | | | | | | |
| | toner | | | | | | | | | | | | | | | | | |
| 2 | polymeri- | B | 0.08 | 0.10 | 0.10 | 0.11 | 0.11 | 0.13 | 0.15 | 0.17 | 0.18 | 0.22 | 0.27 | 0.30 | 0.31 | 0.33 | 0.35 | 0.37 |
| | zation | | | | | | | | | | | | | | | | | |
| | toner | | | | | | | | | | | | | | | | | |
| 3 | pulverization | A | 0.15 | 0.17 | 0.16 | 0.15 | 0.14 | 0.19 | 0.14 | 0.15 | 0.17 | 0.18 | 0.14 | 0.16 | 0.19 | 0.15 | 0.17 | 0.16 |
| | toner | | | | | | | | | | | | | | | | | |
| 4 | pulverization | B | 0.18 | 0.20 | 0.19 | 0.17 | 0.18 | 0.21 | 0.19 | 0.16 | 0.19 | 0.21 | 0.23 | 0.22 | 0.18 | 0.18 | 0.19 | 0.20 |
| | toner | | | | | | | | | | | | | | | | | |

Results of Image Evaluation with Image-Forming Apparatus (Memory Value)

TABLE 2

| | | Photo- | | | | | | | | | | | | | | | | |
|---|---|---|---|---|---|---|---|---|---|---|---|---|---|---|---|---|---|---|
| Evaluation | | receptor | Number of sheets printed (alternate sheets) | | | | | | | | | | | | | | | |
| Example | Toner | drum | initial | 0K | 1K | 2K | 3K | 4K | 5K | 6K | 7K | 8K | 9K | 10K | 11K | 12K | 13K | 14K |
| 1 | polymeri- | A | 0.01 | 0.01 | 0.02 | 0.03 | 0.03 | 0.03 | 0.04 | 0.04 | 0.04 | 0.04 | 0.04 | 0.04 | 0.04 | 0.04 | 0.05 | 0.05 |
| | zation | | | | | | | | | | | | | | | | | |
| | toner | | | | | | | | | | | | | | | | | |
| 2 | polymeri- | B | 0.01 | 0.02 | 0.03 | 0.03 | 0.04 | 0.04 | 0.07 | 0.09 | 0.13 | 0.14 | 0.15 | 0.17 | 0.19 | 0.20 | 0.21 | 0.23 |
| | zation | | | | | | | | | | | | | | | | | |
| | toner | | | | | | | | | | | | | | | | | |
| 3 | pulverization | A | 0.02 | 0.02 | 0.02 | 0.03 | 0.02 | 0.02 | 0.03 | 0.02 | 0.03 | 0.04 | 0.03 | 0.02 | 0.03 | 0.02 | 0.02 | 0.03 |
| | toner | | | | | | | | | | | | | | | | | |
| 4 | pulverization | B | 0.03 | 0.04 | 0.04 | 0.04 | 0.03 | 0.04 | 0.04 | 0.05 | 0.03 | 0.03 | 0.04 | 0.04 | 0.05 | 0.04 | 0.03 | 0.04 |
| | toner | | | | | | | | | | | | | | | | | |

The following were found from the results given in Table 1. In the evaluation using the polymerization toner, photoreceptor drum A of Evaluation Example 1 showed a smaller change in the value of on-drum fogging through the 14,000-sheet printing than photoreceptor drum B of Evaluation Example 2. Photoreceptor drum A gave images of satisfactory quality even after long-term use. With respect to the memory value shown in Table 2 also, photoreceptor drum A of Evaluation Example 1 was found to retain a smaller memory value than photoreceptor drum B of Evaluation Example 2 even after the 14,000-sheet printing in the evaluation with the polymerization toner. Namely, when evaluated with the polymerization toner, photoreceptor drum A was less apt to cause image defects in repetitions of use and showed satisfactory durability.

In Evaluation Examples 3 and 4, in which the photoreceptor drums were evaluated using the pulverization toner, image resolution itself was poor as compared with that in the evaluation with the polymerization toner in Evaluation Examples 1 and 2. When photoreceptor drum A of Evaluation Example 1 was used, high-resolution image quality could be obtained and, even under severe conditions suitable for attaining such high resolution, the image defects were not conspicuous after the 14,000-sheet printing.

As apparent from Tables 1 and 2, when durability was evaluated using the pulverization toner in Evaluation Examples 3 and 4, the photoreceptor drums did not suffer a large deterioration in the value of on-drum fogging or memory value at all. It can be seen from these results that a durability improvement, which is an object of the invention, is necessary only when a polymerization toner is used. It was found that this object can be accomplished with photoreceptor drum A, which employs the specific polymer according to the invention. It was found that although photoreceptor drum A produces no effect when the pulverization toner is used, it produces a remarkable effect concerning durability only when the polymerization toner is used. Thus, a combination of development with the polymerization toner and the electrophotographic photoreceptor of the invention was found to produce a synergistic effect. The object of the invention was found to be accomplished only when this combination is used.

### Example 2

### Production of Photoreceptor Drum C

Ten parts of oxytitanium phthalocyanine which, when examined by X-ray diffraction analysis with CuK_{α} characteristic X-ray, showed a maximum diffraction peak at a Bragg angle (2θ±0.2°) of 27.3° was mixed with 150 parts of 1,2-dimethoxyethane. This mixture was treated with a sand grinding mill for pulverization and dispersion to produce a pigment dispersion. On the other hand, 5 parts of poly(vinyl butyral) (trade name, Denka Butyral #6000C; manufactured by Denki Kagaku Kogyo K.K.) was mixed with 95 parts of 1,2-dimethoxyethane to produce a binder resin solution having a solid concentration of 5%.

160 Parts of the pigment dispersion produced above was mixed with 100 parts of the binder resin solution, an appropriate amount of 1,2-dimethoxyethane, and an appropriate amount of 4-methoxy-4-methyl-2-pentanone to produce a dispersion for charge-generating layer formation through coating. This dispersion had a solid concentration of 4.0% and a (1,2-dimethoxyethane):(4-methoxy-4-methyl-2-pentanone) ratio of 9:1 (by mass).

On the other hand, the surface of an aluminum-alloy cylinder which had an outer diameter of 30 mm, length of 351 mm, and wall thickness of 1.0 mm and the surface of which had been mirror-polished was subjected to anodization and then to a pore-filling treatment with a pore-filling agent containing nickel acetate as the main component. Thus, an anodized coating film (alumite coating) having a thickness of about 6 μm was formed.

This cylinder was then dip-coated with the dispersion for charge-generating layer formation produced above to thereby form a charge-generating layer having a thickness of about 0.4 μm on a dry basis.

Subsequently, this cylinder on which the charge-generating layer had been formed was dip-coated with a coating fluid for charge-transporting layer formation produced by mixing 50 parts of the charge-transporting substance represented by the formula (a) given above with 100 parts of a polymer which was a polycarbonate consisting only of repeating units represented by formula (2) and having a viscosity-average molecular weight of about 50,000 as a binder resin and with a tetrahydrofuran:toluene=80:20 (by mass) mixed solvent. Thus, a charge-transporting layer having a thickness of 18 μm on a dry basis was formed to obtain photoreceptor drum C.

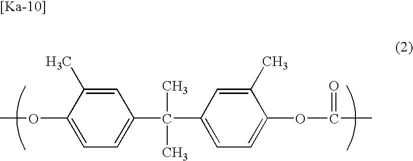

The dispersion used for charge-transporting layer formation through coating in producing photoreceptor drum C had high viscosity stability, and was capable of giving a satisfactory charge-transporting layer free from unevenness, gathering, thickness fluctuations, etc.

### <Production of Toner>

A cyan base toner comprising as the main component a copolymer of styrene and n-butyl acrylate in a molar ratio of 77/23 (peak molecular weight, 3.0×10⁴) produced by the emulsion polymerization aggregation method was mixed in an amount of 1,000 parts with 20 parts of the following silica 1 and 5 parts of the following silica 2 each as external-additive fine particles, by means of a Henschel mixer manufactured by Mitsui Mining Co., Ltd. Thus, a toner for evaluation was produced.

Silica 1: treated with hexamethyldisilazane; primary-particle diameter, about 30 nm

Silica 2: treated with dimethylpolysiloxane; primary-particle diameter, about 7 nm

The toner had a Dv of 7.3 μm and a Dn of 6.4 μm. Furthermore, the toner had a glass transition temperature of 62.5° C.

### <Measurement of Film Loss in Printing Durability Test>

This photoreceptor drum C was mounted in a cartridge for a commercial printer (ML9300, manufactured by Oki Data Corp.). The polymerization toner was used, and this cartridge was mounted as a cyan cartridge in the printer. In an NN environment (25° C.; relative humidity, 50%), 30,000-sheet printing was conducted. The thickness of the photosensitive layer was measured with a micrometer before the printing and every 10,000-sheet printing. The film loss was calculated from the differences between these, and the photoreceptor drum was evaluated based on the following criteria.

The criteria for “evaluation” are as follows.

A: satisfactory durability with extremely small film loss.

B: satisfactory durability with small film loss.

C: poor durability with considerable film loss.

A printing durability test was conducted in the same manner using a commercial printer (ML9300, manufactured by Oki Data Corp.). The film loss through 10,000-sheet printing was 0.42 μm, and the film loss through 20,000-sheet printing was 0.75 μm. In each measurement, the film loss was below 1 μm. Photoreceptor drum C had exceedingly high durability and was rated as A according to the criteria.

### Example 3

### Production of Toner A for Development

### Preparation of Wax/Long-Chain Polymerizable Monomer Dispersion A1

27 Parts (540 g) of a paraffin wax (HNP-9, manufactured by Nippon Seiro Co., Ltd.; surface tension, 23.5 mN/m; melting point, 82° C.; heat of fusion, 220 J/g; half-value width of melting peak, 8.2° C.; half-value width of crystallization peak, 13.0° C.), 2.8 parts of stearyl acrylate (manufactured by Tokyo Kasei Co., Ltd.), 1.9 parts of 20% by mass aqueous sodium dodecylbenzenesulfonate solution (Neogen S20A, manufactured by Dai-ichi Kogyo Seiyaku Co., Ltd.; hereinafter suitably abbreviated to “20% aqueous DBS solution”), and 68.3 parts of desalted water were heated to 90° C. and agitated with a homomixer (Mark II Model f, manufactured by Tokushu Kika Kogyo Co., Ltd.) at a rotation speed of 8,000 rpm for 10 minutes.

Subsequently, the resultant dispersion was heated to 90° C. and subjected to circulating emulsification with a homogenizer (Type 15-M-8PA, manufactured by Golin Co.) under the elevated-pressure conditions of about 25 MPa. This treatment was conducted until the dispersed particles came to have a volume-average particle diameter of 250 nm while examining the dispersion with Microtrac UPA, manufactured by Nikkiso Co., Ltd. (hereinafter suitably abbreviated to “Microtrac UPA”). Thus, wax/long-chain polymerizable monomer dispersion A1 (emulsion solid concentration=30.2% by mass) was produced.

### Preparation of Silicone Wax Dispersion A2

Into a 3-L stainless-steel vessel were introduced 27 parts (540 g) of an alkyl-modified silicone wax (melting point, 72° C.), 1.9 parts of 20% aqueous DBS solution, and 71.1 part of desalted water. The contents were heated to 90° C. and agitated with a homomixer (Mark II Model f, manufactured by Tokushu Kika Kogyo Co., Ltd.) at a rotation speed of 8,000 rpm for 10 minutes.

Subsequently, the resultant dispersion was heated to 99° C. and subjected to circulating emulsification with a homogenizer (Type 15-M-8PA, manufactured by Golin Co.) under the elevated-pressure conditions of about 45 MPa. This treatment was conducted until the dispersed particles came to have a volume-average particle diameter of 240 nm while examining the dispersion with Microtrac UPA. Thus, silicone wax dispersion A2 (emulsion solid concentration=27.4% by mass) was produced.

### Preparation of Primary-Polymer-Particle Dispersion A1

Into a reactor (capacity, 21 L; inner diameter, 250 mm; height, 420 mm) equipped with a stirrer (with three blades), heating/cooling device, condenser, and raw material/aid feeders were introduced 35.6 parts by weight (712.12 g) of wax/long-chain polymerizable monomer dispersion A1 and 259 parts of desalted water. The contents were heated to 90° C. in a nitrogen stream with stirring at a rotation speed of 103 rpm.

Thereafter, a mixture of the following monomers and aqueous emulsifying agent solution was added over 5 hours from the initiation of polymerization. The point of time when the dropwise addition of the mixture of the monomers and aqueous emulsifying solution was initiated was taken as the initiation of polymerization. At 30 minutes after the initiation of polymerization, the aqueous initiator solution shown below began to be added. The initiator solution was added over 4.5 hours. Furthermore, the additional aqueous initiator solution shown below began to be added at 5 hours after the initiation of polymerization, and was added over 2 hours. Thereafter, the reaction mixture was held for 1 hour while maintaining the rotation speed of 103 rpm and the internal temperature of 90° C.

[Monomers]

| | | |
|---|---|---|
| Styrene | 76.8 | parts (1535.0 g) |
| Butyl acrylate | 23.2 | parts |
| Acrylic acid | 1.5 | parts |
| Trichlorobromomethane | 1.0 | part |
| Hexanediol diacrylate | 0.7 | parts |

[Aqueous Emulsifying Agent Solution]

| | | |
|---|---|---|
| 20% Aqueous DBS solution | 1.0 | part |
| Desalted water | 67.1 | part |

[Aqueous initiator Solution]

| | | |
|---|---|---|
| 8% Aqueous hydrogen peroxide solution | 15.5 | parts |
| 8% Aqueous L(+)-ascorbic acid solution | 15.5 | parts |

[Additional Aqueous Initiator Solution]

| | | |
|---|---|---|
| 8% Aqueous L(+)-ascorbic acid solution | 14.2 | parts |

After completion of the polymerization reaction, the reaction mixture was cooled to obtain primary-polymer-particle dispersion A1 as a milk-white liquid. This dispersion had a volume-average particle diameter as determined with Microtrac UPA of 280 nm and a solid concentration of 21.1% by mass.

### Preparation of Primary-Polymer-Particle Dispersion A2

Into a reactor (capacity, 21 L; inner diameter, 250 mm; height, 420 mm) equipped with a stirrer (with three blades) heating/cooling device, condenser, and raw material/aid feeders were introduced 23.6 parts by weight (472.3 g) of silicone wax dispersion A2, 1.5 parts of 20% aqueous DBS solution, and 324 parts of desalted water. The contents were heated to 90° C. in a nitrogen stream. While this mixture was being stirred at 103 rpm, 3.2 parts of 8% aqueous hydrogen peroxide solution and 3.2 parts of 8% aqueous L(+)-ascorbic acid solution were added en bloc thereto.

At 5 minutes thereafter, i.e., at the initiation of polymerization (at 5 minutes after the en bloc addition of 3.2 parts of 8% aqueous hydrogen peroxide solution and 3.2 parts of 8% aqueous L(+)-ascorbic acid solution), the addition of a mixture of the following monomers and aqueous emulsifying agent solution and the addition of the following aqueous initiator solution were initiated. The mixture and the initiator solution were added over 5 hours and 6 hours, respectively. Thereafter, the reaction mixture was held for 1 hour while maintaining the rotation speed of 103 rpm and the internal temperature of 90° C.

[Monomers]

| | | |
|---|---|---|
| Styrene | 92.5 | parts (1850.0 g) |
| Butyl acrylate | 7.5 | parts |
| Acrylic acid | 1.5 | parts |
| Trichlorobromomethane | 0.6 | parts |

[Aqueous Emulsifying Agent Solution]

| | | |
|---|---|---|
| 20% Aqueous DBS solution | 1.5 | parts |
| Desalted water | 66.2 | parts |

[Aqueous initiator Solution]

| | | |
|---|---|---|
| 8% Aqueous hydrogen peroxide solution | 18.9 | parts |
| 8% Aqueous L(+)-ascorbic acid solution | 18.9 | parts |

After completion of the polymerization reaction, the reaction mixture was cooled to obtain primary-polymer-particle dispersion A2 as a milk-white liquid. This dispersion had a volume-average particle diameter as determined with Microtrac UPA of 290 nm and a solid concentration of 19.0% by mass.

### Preparation of Colorant Dispersion A

Into a vessel having a capacity of 300 L and equipped with a stirrer (with propeller blades) were introduced 20 parts kg) of furnace-process carbon black having a true density of 1.8 g/cm³ and giving a toluene extract having an ultraviolet absorbance of 0.02 (Mitsubishi Carbon Black MA100S, manufactured by Mitsubishi Chemical Corp.), 1 part of 20% aqueous DBS solution, 4 parts of a nonionic surfactant (Emulgen 120, manufactured by Kao Corp.), and 75 parts of ion-exchanged water having an electrical conductivity of 2 μS/cm. The pigment was preliminarily dispersed to obtain a pigment premix liquid. The conductivity was measured with a conductivity meter (Personal SC Meter Model SC72 and detector SC72SN-11, both manufactured by Yokogawa Electric Corp.).

In the dispersion obtained through the premixing, the carbon black had a 50% volume-cumulative diameter Dv50 of about 90 μm. The premix liquid was fed as a raw-material slurry to a wet-process bead mill and treated for dispersion by a one-through operation. This dispersing treatment was conducted using zirconia beads having a diameter of about 50 μm (true density, 6.0 g/cm³) as a dispersing medium under the conditions of an inner diameter of the stator of Φ75 mm, a separator diameter of Φ60 mm, and a gap between the separator and disk of 15 mm. The stator had an effective capacity of about 0.5 L and the medium was charged in a volume of 0.35 L; the degree of occupation by the medium was hence 70%. The rotor was operated at a constant rotation speed (the peripheral speed at the rotor front end was about 11 m/sec). The premix slurry was continuously fed through the feed opening with a non-pulsating constant delivery pump at a feed rate of about L/hr and the slurry treated was continuously discharged through the discharge opening. Thus, colorant dispersion A was obtained as a black dispersion. This dispersion had a volume-average particle diameter as determined with Microtrac UPA of 150 nm and a solid concentration of 24.2% by mass.

Production of Base Particles A for Development

| | |
|---|---|
| Primary-polymer-particle dispersion A1 | 95 parts on solid basis |
| | (998.2 g on solid basis) |
| Primary-polymer-particle dispersion A2 | 5 parts on solid basis |
| Fine-colorant-particle dispersion A | 6 parts in solid colorant amount |
| 20% Aqueous DBS solution | 0.1 part on solid basis |

The ingredients shown above were used to produce a toner in the following manner.

Primary-polymer-particle dispersion A1 and 20% aqueous DBS solution were introduced into a mixing vessel (capacity, 12 L; inner diameter, 208 mm; height, 355 mm) equipped with a stirrer (with double helical blade), heating/cooling device, condenser, and raw material/aid feeders. The contents were evenly stirred at 40 rpm at an internal temperature of 12° C. for 5 minutes. Subsequently, the rotation speed of the stirrer was elevated to 250 rpm while maintaining the internal temperature of 12° C., and a 5% aqueous solution of ferrous sulfate was added thereto over 5 minutes in an amount of 0.52 parts in terms of FeSO₄×7H₂O amount. Thereafter, fine-colorant-particle dispersion A was added thereto over 5 minutes. The resultant mixture was evenly mixed while maintaining the internal temperature of 12° C. and the rotation speed of 250 rpm, and a 0.5% aqueous solution of aluminum sulfate was further added thereto dropwise (0.10 part in terms of solid amount per solid resin ingredient) under the same conditions. Thereafter, the internal temperature was increased to 53° C. over 75 minutes and then to 56° C. over 170 minutes while maintaining the rotation speed of 250 rpm. At this point of time, the resultant slurry was examined for particle diameter with a precision particle size distribution analyzer (Multisizer III, manufactured by Beckman Coulter, Inc.) (hereinafter suitably abbreviated to “Multisizer”) regulated so as to have an aperture diameter of 100 μm. As a result, the 50% volume diameter thereof was found to be 6.7 μm.

Thereafter, while maintaining the rotation speed of 250 rpm, primary-polymer-particle dispersion A2 was added to the slurry over 3 minutes and this mixture was held for 60 minutes under the same conditions. The rotation speed was reduced to 168 rpm. Immediately thereafter, 20% aqueous DBS solution (6 parts on solid basis) was added over 10 minutes and the resultant mixture was heated to 90° C. over 30 minutes and held for 60 minutes while maintaining the rotation speed of 168 rpm.

The mixture was then cooled to 30° C. over 20 minutes. The slurry obtained was discharged and subjected to suction filtration through No. 5C filter paper (manufactured by Toyo Roshi Kaisha, Ltd.) using an aspirator. The cake left on the filter paper was transferred to a stainless-steel vessel having a capacity of 10 L and equipped with a stirrer (with propeller blades). Thereto was added 8 kg of ion-exchanged water having an electrical conductivity of 1 μS/cm. This mixture was stirred at 50 rpm to thereby evenly disperse the particles and was then kept being stirred for 30 minutes.

Thereafter, the mixture was subjected again to suction filtration through No. 5C filter paper (manufactured by Toyo Roshi Kaisha, Ltd.) using an aspirator. The solid matter left on the filter paper was transferred again to a vessel having a capacity of 10 L which was equipped with a stirrer (with propeller blades) and contained 8 kg of ion-exchanged water having an electrical conductivity of 1 μS/cm. This mixture was stirred at 50 rpm to thereby evenly disperse the particles and was then kept being stirred for 30 minutes. This step was repeated five times. As a result, the filtrate finally obtained had an electrical conductivity of 2 μS/cm. The conductivity was measured with a conductivity meter (Personal SC Meter Model SC72 and detector SC72SN-11, both manufactured by Yokogawa Electric Corp.).

The cake thus obtained was spread in a stainless-steel vat in a thickness of about 20 mm and dried for 48 hours in an air-circulating drying oven set at 40° C. Thus, base particles A for development were obtained.

### Production of Toner A for Development

A hundred parts (1,000 g) of base particles A for development were introduced into a Henschel mixer having a capacity of 1 L (diameter, 230 mm; height, 240 mm) and equipped with a stirrer (with Z/AO blade) and a deflector extending from an upper part perpendicularly to the wall surface. Subsequently, 0.5 parts of fine silica particles having a volume-average primary-particle diameter of 0.04 μm and hydrophobized with a silicone oil and 2.0 parts of fine silica particles having a volume-average primary-particle diameter of 0.012 μm and hydrophobized with a silicone oil were added thereto. The contents were stirred/mixed at 3,000 rpm for 10 minutes and then filtered through a 150-mesh sieve to thereby obtain toner A for development. Toner A had a volume-average particle diameter Dv and a Dv/Dn both determined with Multisizer of 7.05 μm and 1.14, respectively, and had a 50% degree of circularity as determined with FPIA 2000 of 0.963.

A printing durability test was conducted using a commercial printer (ML9300, manufactured by Oki Data Corp.) in the same manner as in Example 2, except that toner A for development and the same photoreceptor drum C as in Example were incorporated as a black cartridge. As a result, the film loss through 10,000-sheet printing was 0.42 μm, and the film loss through 20,000-sheet printing was 0.75 μm. In each measurement, the film loss was below 1 μm. The photoreceptor drum had exceedingly high durability and was rated as A according to the criteria shown in Example 2.

It was found from the results given above that the electrophotographic photoreceptor of the invention, which contains a polymer comprising repeating units including the partial structure represented by formula (1), shows a sufficiently small film loss and has excellent durability.

While the invention has been described in detail and with reference to specific embodiments thereof, it will be apparent to one skilled in the art that various changes and modifications can be made therein without departing from the spirit and scope thereof. This application is based on a Japanese patent application filed on May 24, 2005 (Application No. 2005-150503) and a Japanese patent application filed on May 25, 2005 (Application No. 2005-151841), the entire contents thereof being herein incorporated by reference.

### INDUSTRIAL APPLICABILITY

The image-forming method of the invention has high resolution and has excellent durability even in long-term repetitions of use. The apparatus can hence be advantageously used in a wide range of apparatus employing an electrophotographic process, such as copiers, laser printers, facsimile telegraphs, and platemaking machines.

1. An electrophotographic photoreceptor for developing an electrostatic latent image formed in the surface thereof with a polymerization toner, the electrophotographic photoreceptor comprising a photosensitive layer which contains a polymer comprising a repeating unit including a partial structure represented by formula (1):

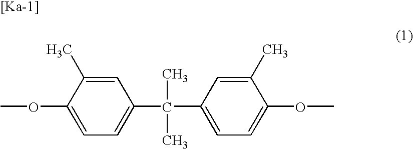

2. The electrophotographic photoreceptor of claim 1, wherein the polymer is a polycarbonate and/or a polyester.

3. The electrophotographic photoreceptor of claim 1 or 2, wherein the polymerization toner has a 50% degree of circularity of 0.9 or higher.

4. The electrophotographic photoreceptor of any one of claims 1 to 3, wherein the polymerization toner has an SF-1 of 140 or lower.

5. The electrophotographic photoreceptor of any one of claims 1 to 4, wherein the polymerization toner is one obtained by an emulsion polymerization aggregation method.

6. The electrophotographic photoreceptor of any one of claims 1 to 5, which is for electrification with a contact charging member.

7. The electrophotographic photoreceptor of claim 6, wherein the contact charging member is a roller type contact charging member.

8. An image-forming apparatus comprising the electrophotographic photoreceptor of any one of claims 1 to 7.
